(19) United States
(12) Patent Application Publication
(10) Pub. No.: US 2018/0285465 A1
(43) Pub. Date: Oct. 4, 2018

(54) METHODS AND APPARATUS FOR COMMUNICATION CHANNEL, DECISION MAKING, AND RECOMMENDATIONS

(71) Applicants: Thomas Grant Schaffernoth, Redwood City, CA (US); Joon Oh, San Carlos, CA (US)

(72) Inventors: Thomas Grant Schaffernoth, Redwood City, CA (US); Joon Oh, San Carlos, CA (US)

(21) Appl. No.: 15/936,150

(22) Filed: Mar. 26, 2018

Related U.S. Application Data
(60) Provisional application No. 62/477,871, filed on Mar. 28, 2017.
(60) Provisional application No. 62/587,363, filed on Nov. 16, 2017.

(51) Int. Cl. G06F 17/30

(52) U.S. Cl. CPC G06F 17/30867; G06F 17/30241; G06F 17/30876; G06F 17/3087

(57) ABSTRACT

Methods and systems for providing a computer platform for social collaboration and decision-making are presented. The computer platform uses rating data associated with different venues to determine venues selectable for an event. A survey webpage is generated based on the determined venues, and a URL link of the webpage is transmitted to potential participants via a communication channel. Based on survey response data received via the survey webpage, the computer platform determines a venue recommendation and presents the venue recommendation on a user device.

### CROSS-REFERENCE TO RELATED APPLICATIONS

This application claims the benefit of and priority to U.S. Provisional Application No. 62/477,871, filed on Mar. 28, 2017, and U.S. Provisional Application No. 62/587,363, filed on Nov. 16, 2017, which are hereby incorporated by reference in their entirety.

### TECHNICAL FIELD

The present application generally relates to systems and methods for implementing recommendations and social collaboration with respect to venues; and more specifically to mobile apps providing dynamic restaurant recommendations.

### BACKGROUND

There are websites that show customer ratings for restaurants such as YELP™, TRIPADVISOR™, ZAGATS™, RESTAURANT.COM™, OPEN TABLE™, and DINE.COM™. These sites provide dialog boxes for customers to insert their text comments and reviews of restaurants, along with quantitative ratings, frequently on a one to five star scale or other such numerical scale. The websites will then display the aggregate numerical ratings, along with specific comments for review by other customers.

However, while these websites provide ratings and customer reviews based on input from previous customers, they do not provide personalized recommendations nor do they include input from other similar users. Thus, while the ratings may provide information on the ratings and comments from all the people who have submitted them, the ratings do not necessarily provide insights useful to the user.

Moreover, users frequently find it difficult to determine a venue for multiple participants to meet, such as due to suitable dates, times, restaurants, categories of cuisine, and the like. Thus, there is a need for an improved system or application for providing dynamic and personalized venue recommendations.

### BRIEF DESCRIPTION OF THE DRAWINGS

FIG. 1 is a block diagram of a networked system suitable for implementing the processes described herein, according to an embodiment.

FIG. 2 is a flowchart of a process for implementing surveys according to an embodiment.

FIGS. 3A-3C illustrate process flows for survey creation, collaboration, and communication channel according to an embodiment.

FIG. 3D illustrate a process flow for history functions according to an embodiment.

FIG. 4 is a flowchart of a process for implementing various functions of survey application according to an embodiment.

FIG. 5A illustrates a process flow for venue selection according to an embodiment.

FIGS. 5B and 5C illustrate process flows for various social functions according to an embodiment.

FIG. 5D illustrates a process flow for comments functions according to an embodiment.

FIG. 5E illustrates a process flow for details functions according to an embodiment.

FIG. 5F illustrates a process flow for open times functions according to an embodiment.

FIG. 5G illustrates a process flow for ratings functions according to an embodiment.

FIG. 5H illustrates a process flow for opinions functions according to an embodiment.

FIG. 6 illustrates a diagram of databases according to an embodiment.

FIGS. 7A-7E illustrate various display interface of a device for implementing surveys according to an embodiment.

FIG. 8 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

In an embodiment, a method and apparatus are provided for social collaboration and decision-making, comprising: a communication channel or communication device; a database containing ratings of criteria for meetings, venues, events, restaurants or potential results for decision-making; presenting options for the meetings, venues, events, restaurants or other potential results for decision-making; and using the communication channel, device or other means to collaborate with users. In one example embodiment (and not by way of limitation), the system comprises a communication channel wherein a first user utilizes a portion of the database to review or search for ratings for various criteria for restaurants or other events, venues or meetings to determine a set of options. The first user then uses the communication channel or device to present that set of options to a second user (or multiple users). The second user (or multiple users) then responds regarding the set of options via the communication channel. Alternatively, the second user (or multiple other users) may present additional or different options. A decision may be made automatically or manually by the users. In an example embodiment, the options may include restaurant or cuisine category choices, potential meeting dates and times. In one embodiment, the communication channel may utilize SMS text messaging, email, chat, mobile, or a customized delivery system.

In an embodiment, a method and apparatus for making personalized recommendations, comprising: a database of user ratings for criteria; categorization of users based on ratings to selected criteria; determining subset of users based on ratings to the selected criteria; and generating personalized recommendations to users within that subset of users based on ratings of other users within that subset. In an embodiment, the subset or a tribe of users is determined by similar ratings to the selected criteria. In that embodiment, users who have similar tastes or preferences are categorized into a subset or a tribe. Recommendations from those users are likely to be more valuable to other users of similar tastes or preferences than recommendations from those with dissimilar tastes or preferences or recommendations from the general population. Users may be in multiple subsets or tribes. As data increases, decreases, or fluctuates, users may be categorized into different subsets or tribes. The tribes or interest groups may be dynamic, such that they may change over time, as users' interests may change over time, as new tribes may be created, old tribes deleted, different tribes merged or divided.

In some embodiments, systems and methods may provide a communication channel, restaurant recommendations and survey for participants to input dates, times, venues, restaurants and/or categories of cuisine. The systems and methods may enable each participant to vote on date, time, venue, restaurant and/or cuisine category options and see the survey results showing date, time, venue, restaurant, and/or cuisine category selections. This streamlines the communication and decision making for the date, time, venue, restaurant, and/or cuisine category selections.

In some embodiments, the survey results may be visible to all participants, but do not necessarily need to be visible to all and may only be visible to the originator of the survey or a select subset of participants. In an example, the originator of the survey selects the dates, times, restaurants, and/or cuisine categories based on the information provided by the survey from the participants via the communication channel. In an embodiment, the systems or methods may implement automatic decision-making of the survey results and provide that decision back to the originator of the survey for distribution to all participants or direct distribution to all participants. Another embodiment provides for compilation of survey results back to the survey originator for decision and then distribution of decision to participants.

It should also be appreciated that the present disclosure is not limited to restaurant selections, but may include any type of venue or event selection, such as hotels, concerts, sporting events, meeting locations, celebrations, etc. For example, but not by way of limitation, the survey selections may include date, time and hotel or venue options for meetings. Alternatively, the selections may include travel options, destinations, project or product results or milestones, or anything requiring voting or decision making.

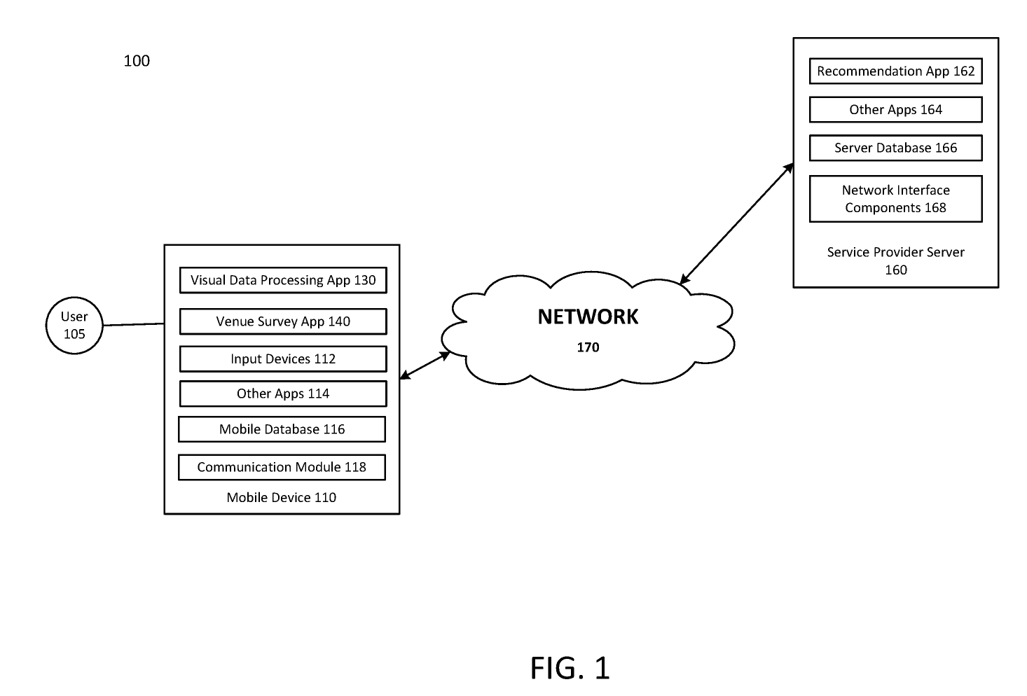

FIG. 1 is a block diagram of a networked system 100 suitable for implementing the processes described herein, according to an embodiment. As shown, system 100 may comprise or implement a plurality of devices, mobile devices, servers, and/or software components that operate to perform various methodologies in accordance with the described embodiments. Examples of devices and servers may include device, mobile devices, stand-alone, and enterprise-class servers, operating an OS such as a Mobile Operating System (iOS, Android OS, or others), a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a mobile device 110 and a service provider server 160 in communication over a network 170. A user 105 (not shown) may utilize mobile device 110 to utilize the various features available for mobile device 110, which may include processes and/or applications (e.g., mobile apps) associated with service provider server 160 to implement surveys and recommendations. For example, the user 105 may utilize a mobile app installed on mobile device 110 to search and select venues or restaurants. The mobile app may present basic information, ratings, comments while also allow the user 105 to create surveys and plan meetings with other users at the selected venue or restaurant. Service provider sever 160 may interact with mobile device 110 over network 170 to facilitate and process user 105's requests and communicate with other users.

Mobile device 110 and service provider server 160 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

Mobile device 110 may be implemented as a communication device that may utilize appropriate hardware and software configured for wired and/or wireless communication with service provider server 160. For example, in one embodiment, mobile device 110 may be implemented as a personal computer (PC), telephonic device, a smart phone, laptop/tablet computer, wristwatch with appropriate computer hardware resources, eyeglasses with appropriate computer hardware (e.g. GOOGLE GLASS®), Virtual Reality (VR) glasses, other type of wearable computing device, implantable communication devices, and/or other types of computing devices capable of transmitting and/or receiving data, such as an IPAD® from APPLE®. Although only one communication device is shown, a plurality of mobile devices may function similarly.

Mobile device 110 of FIG. 1 contains a voice recognition application 120, a visual data processing application 130, a survey app 140, input devices 112, other applications 114, a mobile database 116, and a communication module 118. Survey app 140 and other applications 114 may correspond to executable processes, procedures, and/or applications with associated hardware. In other embodiments, mobile device 110 may include additional or different modules having specialized hardware and/or software as required.

Visual data processing application 130 may correspond to one or more processes to execute software modules and associated devices of mobile device 110 to receive or record visual data and process the visual data to determine an object or a person, such as a venue location, a restaurant menu, the identity of a user, or the like, as well as generate the contextual and other data necessary to generate survey, comments, and/or venue recommendations. In this regard, visual data processing application 130 may correspond to specialized hardware and/or software utilized by a user of mobile device 110 that first receives, captures, and/or records video data, including audiovisual data. Thus, visual data processing application 130 may utilize a camera or other optical/visual data capturing device of input devices 112. The captured video data may provide contextual data allowing for identification of a venue or items related to a venue. The video data may include other users associated with the user 105 or other contextual data identifying the associated other users, including an image or video of other users associated with the second user.

Additionally, the captured visual data by visual data processing application 130 may be used to determine an augmented reality, where additional information or objects are displayed as graphics by visual data processing application 130 overlaid onto the displayed environment. In an embodiment, a user may use a street survey app to point a camera view of a mobile device at a street location or a scene, and the system may generate an augmented reality to populate the view with various restaurants and attributes.

Survey app 140 may correspond to one or more processes to execute software modules and associated devices of mobile device 110 to perform venue selection, survey creation, communication, venue recommendation, rating, venue meeting coordination and the like. In this regard, survey app 140 may correspond to specialized hardware and/or software utilized by a user of mobile device 110 that initially allows the user to access an app interface provided by service provider server 160. The user 105 may search and select a venue, such as a restaurant. The survey app 110 may present various information regarding the selected venue to the user 105. Thus, the user 105 may view various information of the venue, such as basic description, location, rating, comments, posted images or videos. For example, images and/or comments posted by other users may be presented to the user 105 via survey app 140.

Survey app 140 may also provide survey and/or meeting planning services, for example, through one or more processes that provide an interface to permit the user to enter input and other data for creating and communicating a survey to other users, for example, through an input device (e.g., touch screen with a graphical user interface, keypad/keyboard, mouse, etc.) and/or through a data capture device (e.g., scanner, camera, other optical device, etc.).

Survey app 140 may utilize one or more user interfaces, such as graphical user interfaces presented using an output display device of mobile device 110, to enable the user associated with mobile device 110 to perform various survey functions. In various embodiments, survey app 140 may correspond to a general browser application or a mobile app interface configured to retrieve, present, and communicate information over the Internet (e.g., utilize resources on the World Wide Web) or a private network. For example, survey app 140 may provide a web browser or a mobile app interface, which may send and receive information over network 170, including retrieving website or app information (e.g., a website or an app provided by service provider server 160), presenting the website or app information to the user, and/or communicating information to the website or the app service. However, in other embodiments, online shopping application 140 may include a dedicated application of service provider server 160 or other entity (e.g., a merchant), which may be configured to assist in processing transactions. The interface(s) providing by survey app 140 may be utilized to enter venue related information, transaction information, and receive venue related information from service provider server 160.

In various embodiments, mobile device 110 includes other applications 114 as may be desired in particular embodiments to provide features to mobile device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking applications. Other applications 114 may also include other location detection applications, which may be used to determine a location for the user, such as a mapping, compass, and/or GPS application, which can include a specialized GPS receiver that obtains location information for mobile device 110 and processes the location information to determine a location of mobile device 110 and the user. Other applications may include social networking applications, media viewing, and/or merchant applications. Other applications 114 may include device interface applications and other display modules that may receive input from the user and/or output information to the user. For example, other applications 114 may contain software programs, executable by a processor, including a graphical user interface (GUI) configured to provide an interface to the user. Other applications 114 may therefore use devices of mobile device 110, such as display devices capable of displaying information to users and other output devices, including speakers.

Mobile device 110 may further include a mobile database 116 stored in a transitory and/or non-transitory memory of mobile device 110, which may store various applications and data and be utilized during execution of various modules of mobile device 110. Thus, database 116 may include, for example, identifiers such as operating system registry entries, cookies associated with online shopping application 140 and/or other applications 114, identifiers associated with hardware of mobile device 110, or other appropriate identifiers, such as identifiers used for payment/user/device authentication or identification, which may be communicated as identifying mobile device 110 to service provider server 160. In various embodiments, account information and/or digital wallet information may be stored on database 116 for use by mobile device 110. Database 116 may also store captured audio, video, or audiovisual content. Additionally, venue data, contextual data in the captured content, surveys, venue recommendations, user preferences, planned meetings may be stored on database 116 where applicable. Moreover, an augmented reality and/or graphics overlaid onto a display of a captured environment may be stored in database 116.

Mobile device 110 includes at least one communication module 118 adapted to communicate with service provider server 160. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, Bluetooth Low Energy (BLE) beacons, and near field communication devices. Communication module 118 may communicate directly with nearby devices (e.g., other mobile devices 150) using short range communications, such as Bluetooth Low Energy, LTE Direct, WiFi, radio frequency, infrared, Bluetooth, and near field communications.

Service provider server 160 may be maintained, for example, by an app service provider who provides survey and recommendation services. In this regard, service provider server 160 includes one or more processing applications which may be configured to interact with mobile device 110, and/or another device/server to facilitate survey and recommendation of venues. In one example, service provider server 160 may be provided by NEARCHUS, Inc. (LetsMeet2Eat) of Redwood City, Calif., USA. However, in other embodiments, service provider server 160 may be maintained by or include another type of service provider, which may provide connection services to a plurality of users.

Service provider server 160 of FIG. 1 includes a recommendation application 162, other applications 164, a server database 166, and a network interface component 168. Recommendation application 162 and other applications 164 may correspond to executable processes, procedures, and/or applications with associated hardware. In other embodiments, service provider server 160 may include additional or different modules having specialized hardware and/or software as required.

Recommendation application 162 may correspond to one or more processes to execute software modules and associated specialized hardware of service provider server 160 to provide venue survey and recommendation services to users, for example, by generating venue information, surveys, and recommendations based on user requests received from mobile device 110.

Recommendation application 162 may also determine an electronic communication channel for distribution or communication of venue surveys and/or recommendations to other users. The selected electronic communication channel may be based on a preference of the users, an available channel to service provider server 160, and/or based on past use of the channel and/or reactions to surveys or recommendations. Once selected, recommendation application 162 may communicate the venue survey and/or recommendations to other users using the electronic communication channel.

In various embodiments, service provider server 160 includes other applications 164 as may be desired in particular embodiments to provide features to service provider server 160. For example, other applications 164 may include security applications for implementing server-side security features, programmatic client applications for interfacing with appropriate application programming interfaces (APIs) over network 170, or other types of applications. Other applications 164 may contain software programs, executable by a processor, including a graphical user interface (GUI), configured to provide an interface to the user when accessing service provider server 160, where the user or other users may interact with the GUI to more easily view and communicate information. In various embodiments, other applications 164 may include connection and/or communication applications, which may be utilized to communicate information to over network 170.

Additionally, service provider server 160 includes one or more server database 166. The user 105 may establish one or more accounts with service provider server 160. User accounts stored in database 166 may include user information, such as name, address, birthdate, payment instruments/funding sources, additional user financial information, user venue preferences, and/or other desired user data. Thus, when an identifier is transmitted to service provider server 160, e.g., from mobile device 110, one or more accounts belonging to the users may be found. Database 166 may also store the user preferences for an account for the user. Database 166 may also store transaction information.

In various embodiments, service provider server 160 includes at least one network interface component 168 adapted to communicate mobile device 110 over network 170. In various embodiments, network interface component 168 may comprise a DSL (e.g., Digital Subscriber Line) modem, a PSTN (Public Switched Telephone Network) modem, an Ethernet device, a broadband device, 3G/4G/LTE/5G modem, a satellite device and/or various other types of wired and/or wireless network communication devices including microwave, radio frequency (RF), and infrared (IR) communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

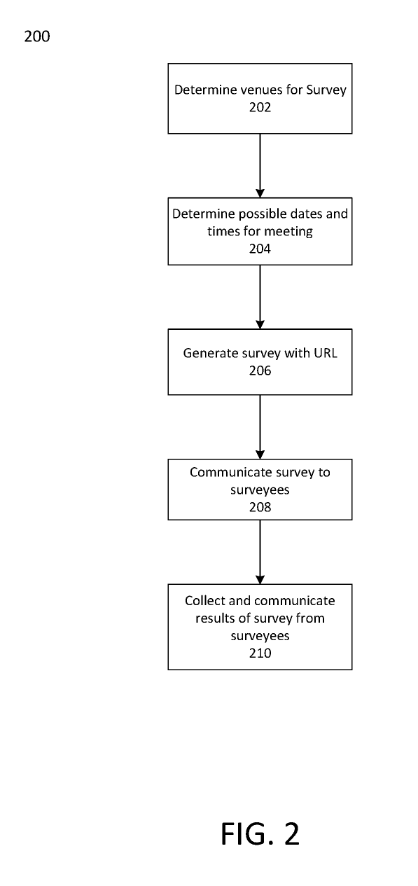

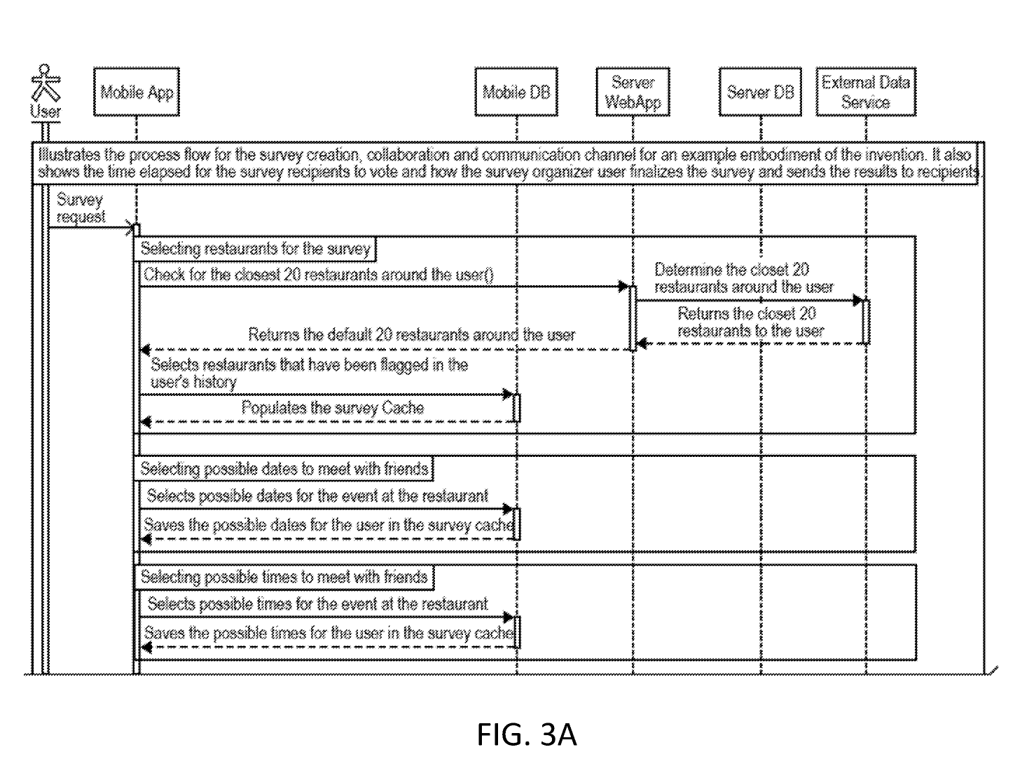

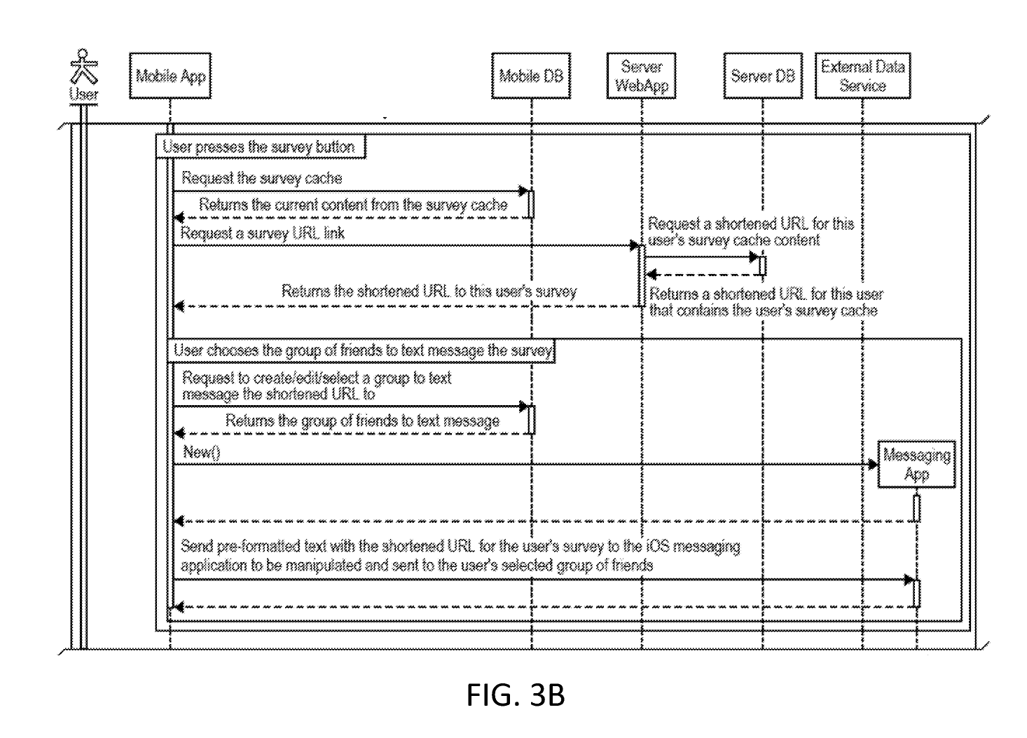

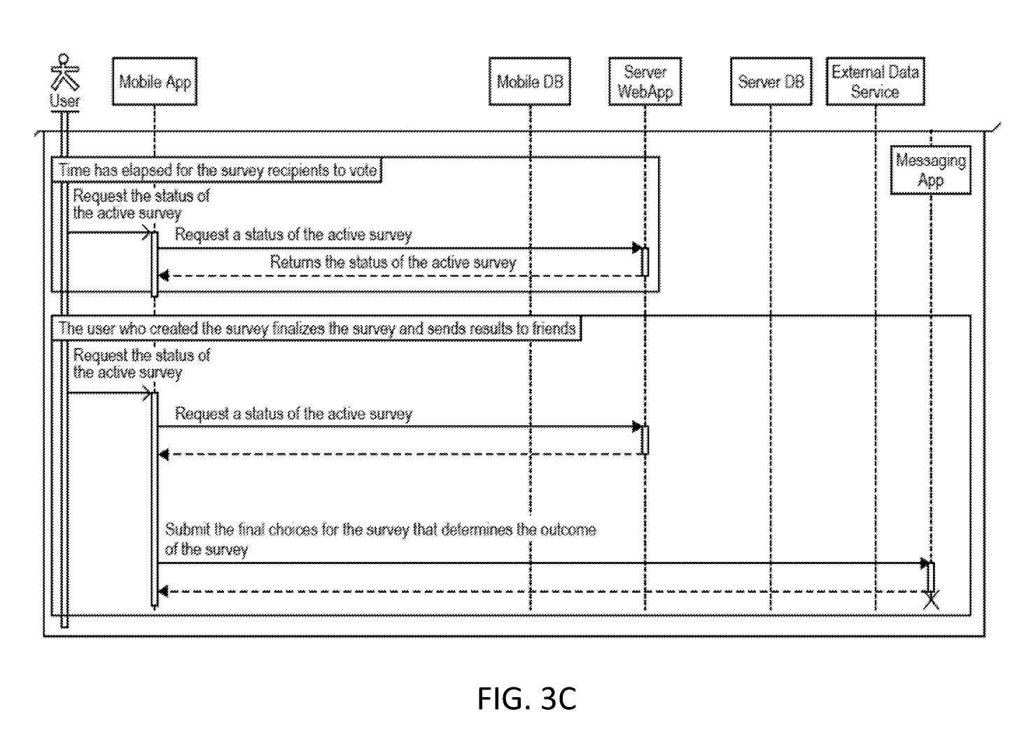

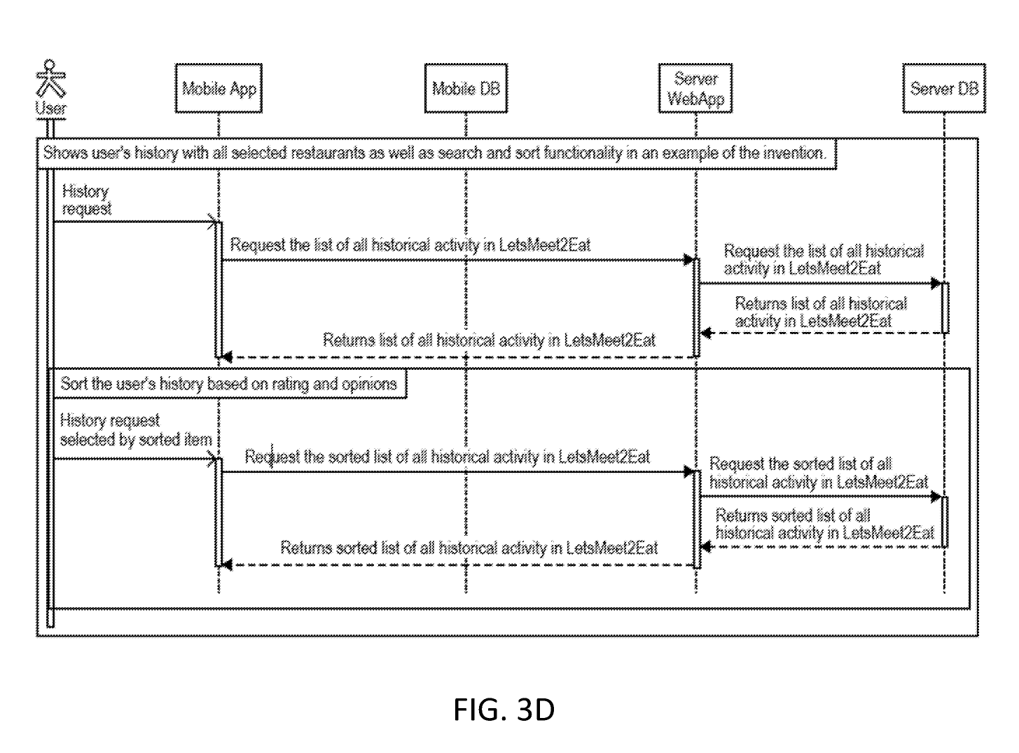

FIG. 2 is a flowchart of a process 200 for implementing surveys according to an embodiment. The survey process 200 may be performed by mobile device 110, by service provider server 160 or by both mobile device 110 and service provider server 160 in coordination with each other. For example, process 200 may allow user 105 (e.g., the survey originator) to create a survey requesting opinions about dates, times, restaurant options and/or cuisine categories, and then send that survey to a target group of other users. FIG. 3A illustrate a process flow corresponding to process 200 for implementing surveys.

At step 202 in FIG. 2, the system may allow a user to select venues for survey. For example, in a survey creation interface (e.g., app screen) of the survey mobile app 140, the user 105 may click on a “We Recommend” icon to initiate a survey request, as shown in FIG. 3A. The survey request may be forwarded to the service provider server 160, which may return a list of venues (e.g., 20 or more restaurants located closest to the user 105). As shown in FIG. 3A, the user 105 or survey organizer may select the restaurants that he/she wishes to include in the survey. This selection is then sent from the mobile application to the service provider server 170 (e.g., web application server). By way of example, but not limitation, the mobile application determines the geolocation of the user through the user device and checks for restaurants in the vicinity of the user. Similarly, the mobile application may check for restaurants in the geographic vicinity of the map parameters. This query is sent to the web application server which then sends the query to an external data service for determination of restaurants that meet the criteria. It should be noted that additional criteria may be added or established. The external data service returns the data of the closest 20 restaurants to the user to the web application server which then returns the data to the mobile application. In an alternative embodiment, the mobile application may identify or prepopulate with restaurants that have been flagged in the user's history. In any event, the user 105 selects a set of the restaurants to use in the survey or enter an actual address to be used for finding restaurants. This set of restaurants populates the survey cache which is stored in the mobile database.

In some embodiments, the mobile application may display a restaurant activity stream. This shows previous ratings of restaurants in various classifications. Some of the ratings classifications are the following: (1) flagged or noted restaurants; (2) food; (3) service; (4) value; (5) beverages; (6) cleanliness; (7) chronology of rated or flagged restaurants; (8) family and kids; (9) date night; (10) happy hour; (11) girls night out; (12) guys night out; (13) business; (14) casual; (15) groups of 10 or more; (16) groups of 10 or less; (17) singles night; (18) elegant; (19) car parking; (20) bike parking; (21) outdoor seating; (22) wifi; (23) Watch TV; (24) handicapped accessible; (25) music; (26) dancing. Additional ratings classifications may be included and the system may include any subset thereof or none of the ratings classification.

The survey originator then selects the restaurants or categories of cuisine. The mobile application may generate a map of restaurants within the vicinity of the map parameters. The user may then select restaurants or categories of cuisine for the survey. Additionally, the disclosure contemplates uses other than restaurant selections. For example, selections may include meeting places, movies, hotels, shopping, sporting or athletic events, parks, gyms, community centers, entertainment, houses or businesses of the users or others, and a wide range of other activities or locations.

At step 204 in FIG. 2, the system may allow the user 105 to select possible dates and times for meeting. As shown in FIG. 3A, the user 105 or survey organizer also selects possible times to meet. This selection of times is sent from the mobile application to the mobile database and stored in the survey cache. In this example, the user or survey organizer also selects possible dates to meet. This selection of dates is sent from the mobile application to the mobile database and stored in the survey cache.

As shown in FIG. 3B, the user 105 may press on a survey button in the mobile app (e.g., survey app 140), the mobile app then requests the survey cache (containing restaurant selections, and possible dates and times) from the mobile database. The mobile application then requests a survey URL link from the service provider server 160 (e.g., the web application server). The web application server requests a shortened URL for the user's survey cache content from the server database. This shortened URL is now sent from the server database to the web app server and then returned to the mobile application.

After survey information has been collected from the user, the mobile app may allow the user 105 to preview and send the survey via text messaging to the identified group of participants, as shown in FIG. 3B. In an embodiment, the service provider server 160 may generate and provide an URL link to the survey at step 206. The user 105 may then copy and forward the URL link to the target group of other users to be surveyed at step 208.

The survey originator selects options for date(s) and time(s). The survey originator then selects the recipients of the survey. Once all of the inputs are made, the survey originator then sends the survey to the selected recipients. Note that the order of the selection may vary. For example, date and/or time may be selected before recipients or restaurant or activity or location. Additionally, the present disclosure contemplates that the survey may include a subset of the data described above. For example, a user may send a survey request for just date or time, without restaurant, activity or location. Similarly, a user may send a survey request for restaurant or activity or location without date, time or other information.

In some embodiments, the user/survey organizer chooses the recipient(s) to send a text message containing the survey. The mobile application sends a request to create/edit/select recipient(s) to text message the shortened URL to the mobile database 116. The mobile database 116 accesses contact information for the recipient(s) and returns the sample text message to the mobile application. The message may be edited or sent in its pre-formatted state with shortened URL for the user's survey. It is then sent via the messaging application to the selected recipient(s). Note that the selected recipient(s) may receive the message via the messaging application and need not have already downloaded the mobile application.

In some embodiments, the target survey participants may receive a text message with instructions on how to vote for date, time and restaurant choices. At step 210, the votes are sent to the survey organizer who then reviews all the votes and finalizes the survey with a decision based on the survey results. At any time, the user 105, as the survey organizer, may review the progress of the surveys during the voting time.

FIG. 3C also shows the process for requesting status of a survey. The mobile application sends the request for status of the survey to the web application server which returns the status of the survey to the mobile application. FIG. 3C also shows the process for finalizing a survey and sending the results to the recipients. The mobile application requests a status of a survey from the web application server which returns the status of the survey to the mobile application. The survey organizer or user then submits the final choices for the survey via the mobile application to the web application server and then returned to the mobile application. The mobile application then sends pre-formatted text with a shortened URL or link containing final decision-making or outcome of the survey to the messaging application which then sends it to the survey recipients.

In one embodiment, the code provides for automated reminders for users who have not yet participated in the survey. Alternatively, the organizer may manually send out reminder notifications. In an embodiment, after all the survey results are received, the organizer then sends a text message to all the recipients of the final decisions. Note that there is no requirement for the survey participants to have the application installed on their computers or mobile phones or devices.

It should be noted that alternative embodiments provide for the decision-making of the final results to be automated. For example, the decision-making may be automated by an algorithm that takes into account the selections of a majority of the voting participants. This decision may be sent out to all survey participants or sent to the originator for approval and then if approved, sent to all survey participants. Also, if some of the participants are slower to fill out the survey, the automated algorithm may also have a time sensitive component that provides for decision-making when a majority of the participants have voted or when there is a deadline or pre-set time that has passed. For example, if the event is to take place on Friday or Saturday, and a number of participants have voted by Thursday, then an algorithm may provide for the survey results to be finalized as of Thursday and sent to all participating and non-participating survey users to enable the event logistics to take place by the desired time. Survey originator may also have visual cues to see if someone has responded to the survey.

FIG. 3D illustrates a flow process for presenting a user's history with all selected restaurants as well as search and sort functionality according to an embodiment. In one embodiment, a user may review his or her activity using the “History” icon. The user may sort his or her history based on the following criteria: Food, Service, Value, Beverages, Cleanliness, Flagged Restaurants and Chronological date/time of the activity. Alternative embodiments may include additional or substitute criteria for review in the History feature.

In an embodiment, when the user selects the history icon, the mobile application requests the list of all historical activity in the mobile application concerning this user or concerning certain restaurants to the web application server. In this functionality, restaurants may include all those that a user has flagged, rated, or provided an opinion, taken pictures or any other activity. The web app server requests this data from the server database. The server database returns the list of all historical activity regarding that user in the mobile application to the web app server which then returns the list to the mobile application.

In an alternative embodiment, the user may request that the history be sorted or searched by certain criteria. The mobile application then requests the sorted or searched list of all historical activity in the mobile application concerning this user or concerning certain restaurants to the web application server. In this functionality, restaurants may include all those that a user has flagged, rated, or provided an opinion, taken pictures or any other activity. The web app server requests this data from the server database. The server database returns the sorted or searched list of all historical activity regarding that user in the mobile application to the web app server which then returns the list to the mobile application.

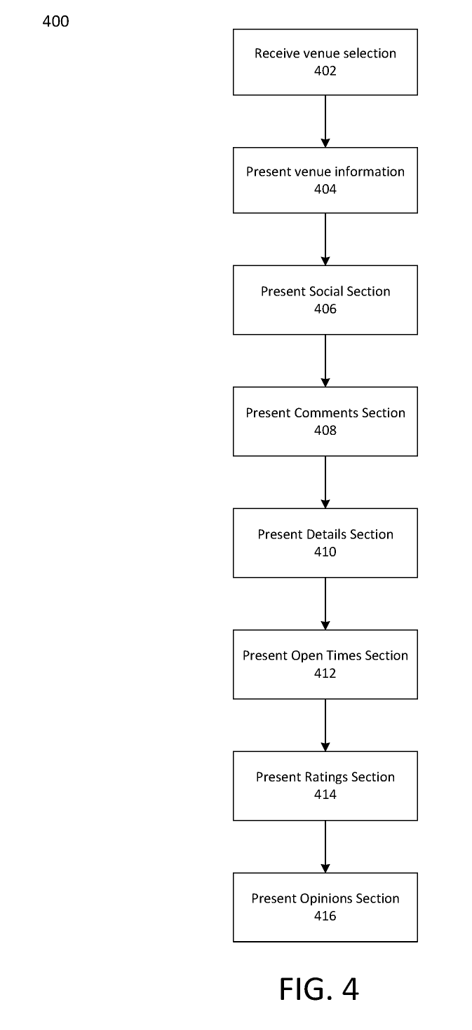

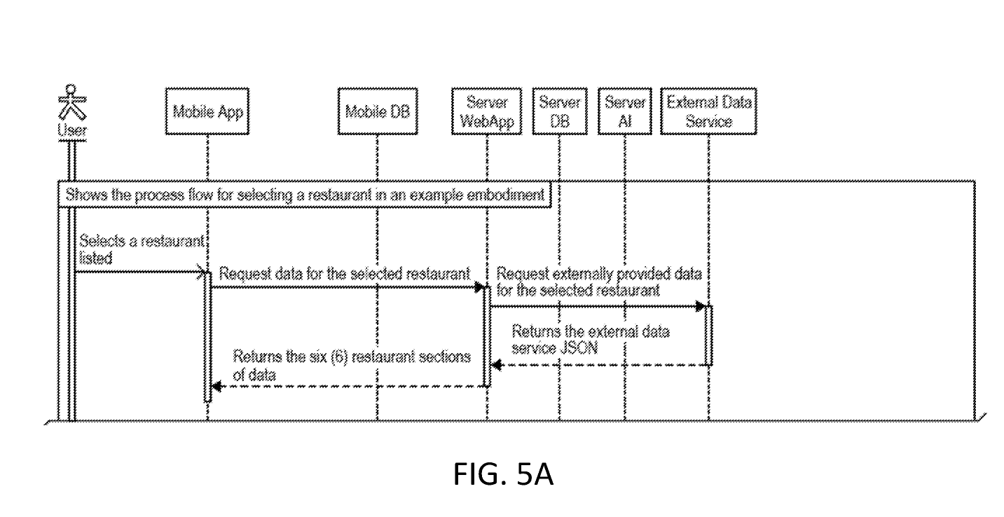

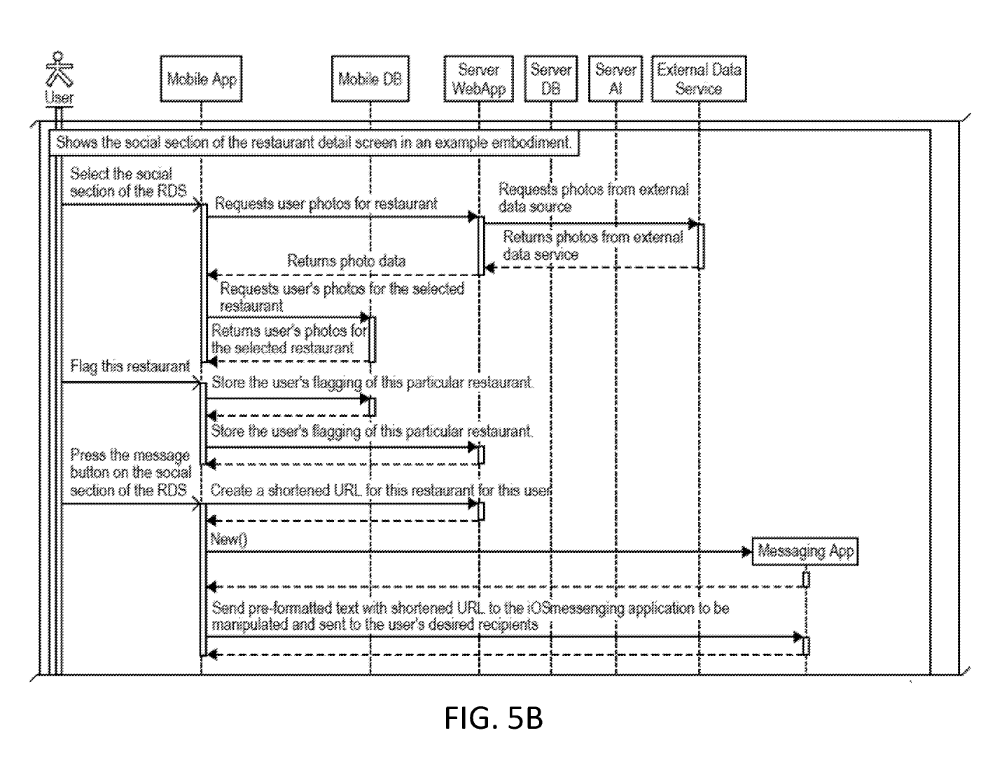

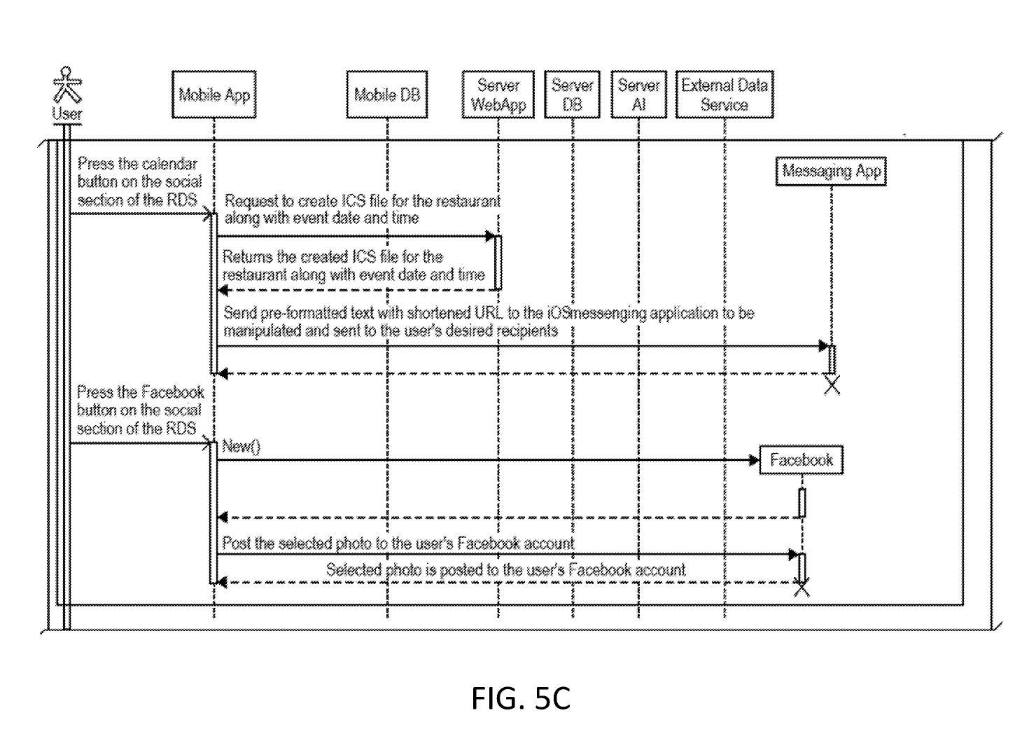

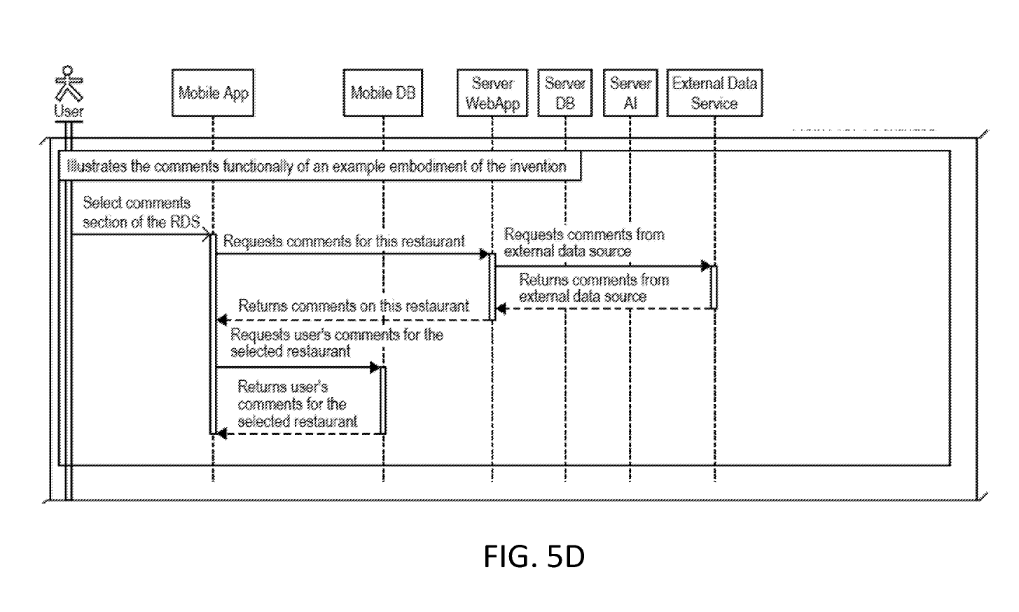

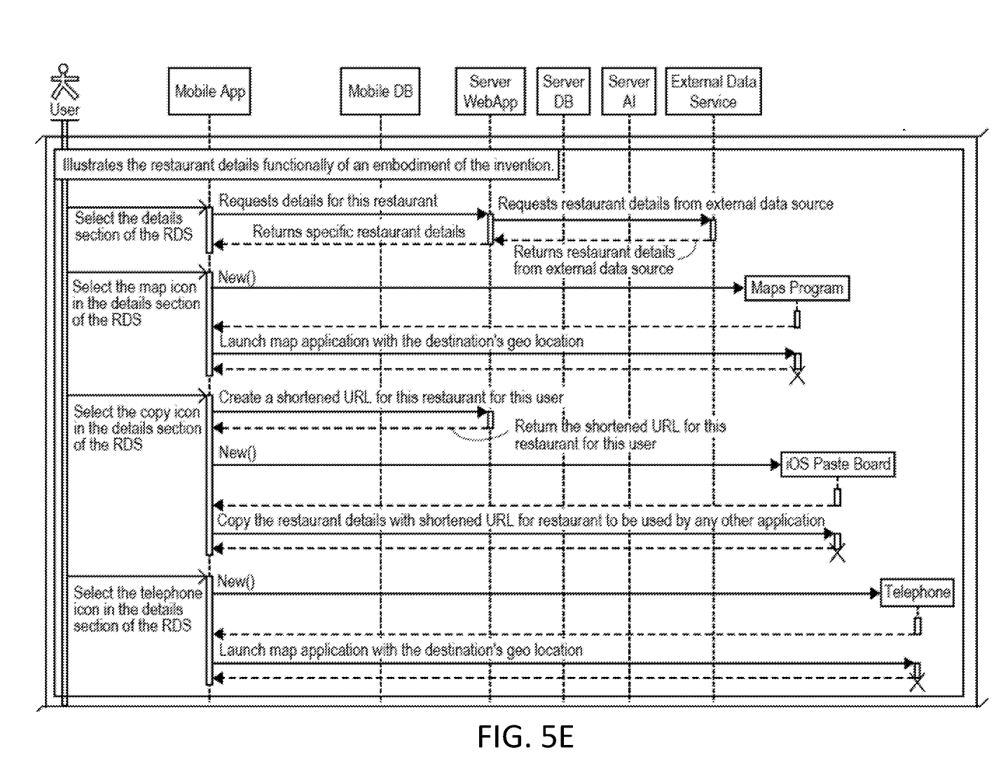

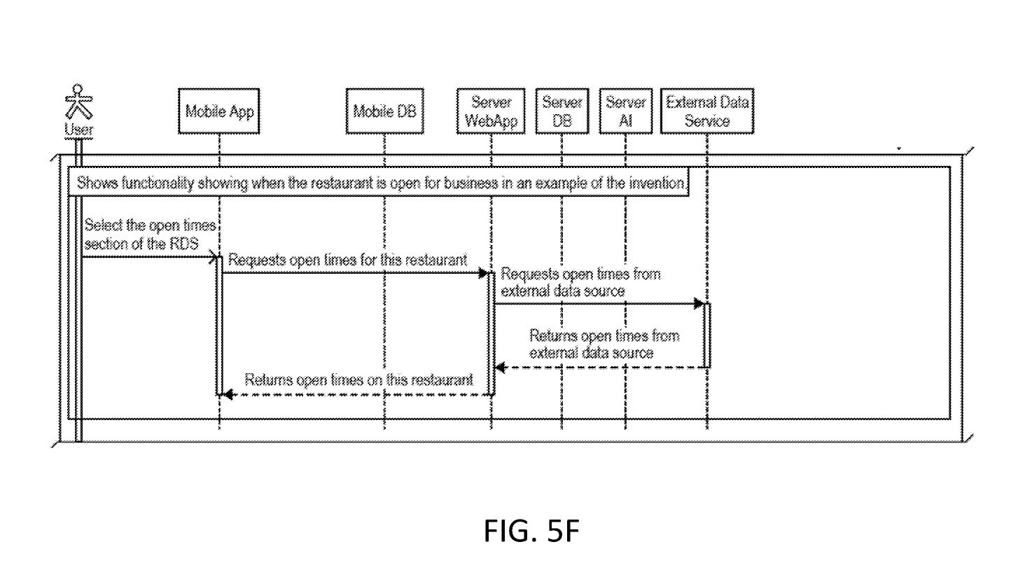

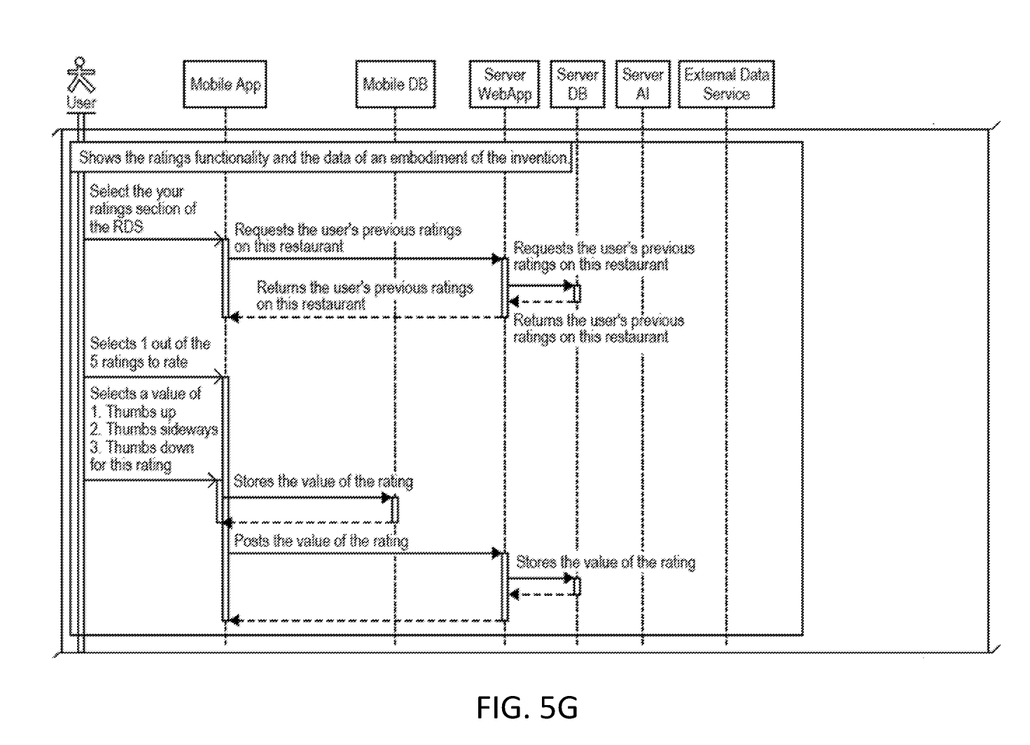

FIG. 4 is a flowchart of a process 400 for implementing various functions of survey application according to an embodiment. The process 400 may correspond to flow processes illustrated in FIGS. 5A-5H. At step 402 in FIG. 4, the system may receive venue selection. For example, as shown in FIG. 5A, as the user interacts with the screen of mobile device 110 or cell phone, the mobile application requests data for the selected restaurant to the web application server 160. That server 160 then requests data regarding the selected restaurant from external data servers. The external data server then sends the information to the web app server which then returns the information regarding the selected restaurant to the mobile application for display at step 404. In some embodiments, multiple sources for the external data servers, such as search engines like Google™, Yahoo!™ and Bing™ that may store database information on selected restaurants. In some embodiments, the search may also include retrieval of information on other items, such as but not limited to, hotels, concerts, sporting events, meeting locations, celebrations, etc.

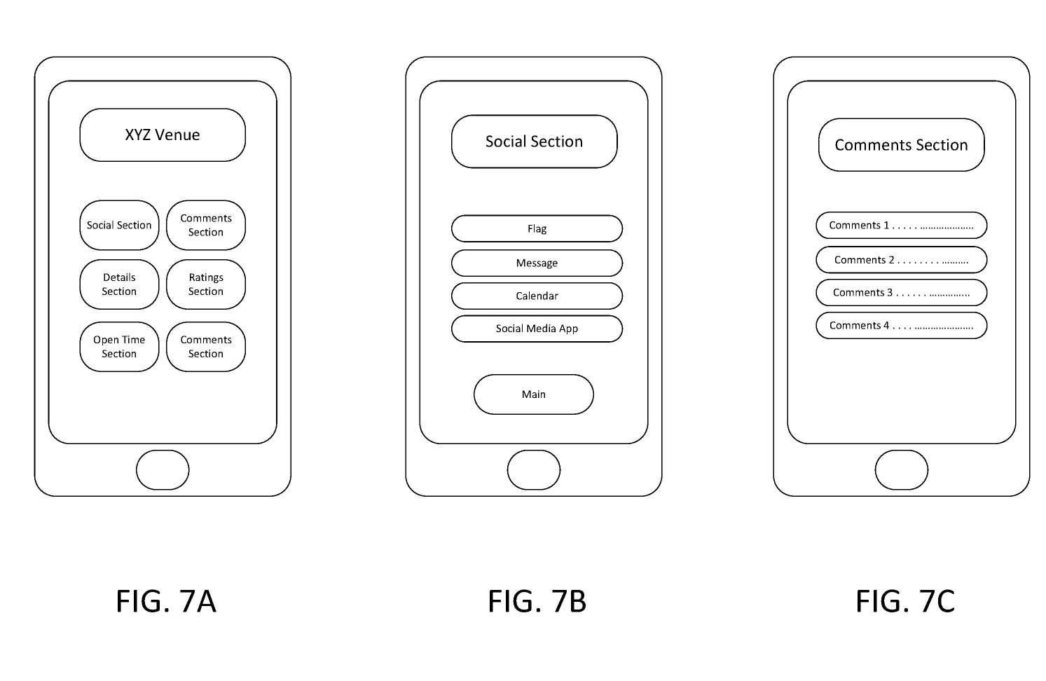

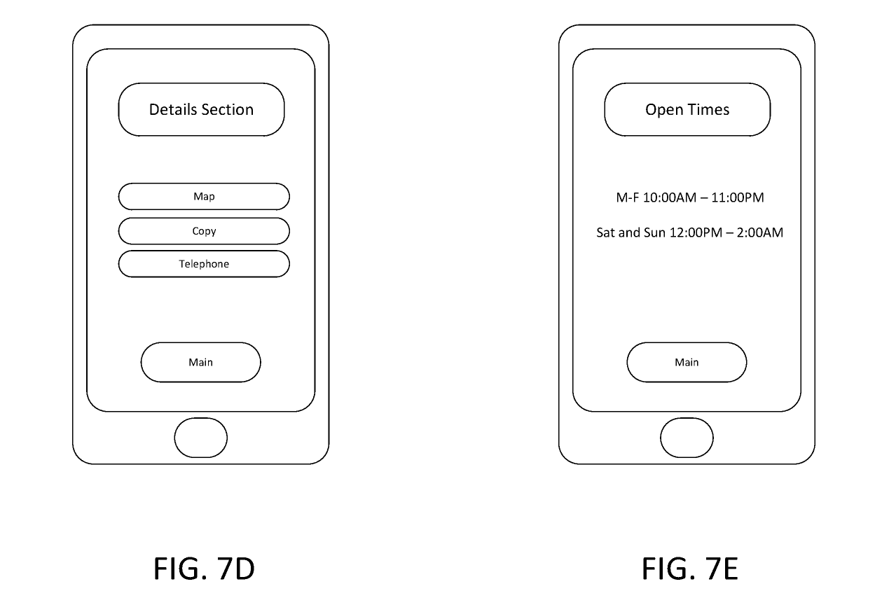

The retrieved information may be presented to the user in a restaurant detail screen. As shown in FIG. 7A, the restaurant detail screen may include a plurality of functional icons, such as social, comments, details, ratings, open time, and comments, that are selectable by the user 105 to access corresponding functions.

In some embodiments, the user 105 may open the mobile app on the mobile device 110 and point the camera of the mobile device 110 at the menu (e.g., hover) to show specific content from the menu, such as content associated with an item on the menu. In particular, the user 105 may hover the mobile device 110 over a restaurant's menu to implement AR on top of the menu. For example, utilizing the augmented reality functions of the mobile device 110, the user 105 may scan over the restaurant menu and the mobile device 110 may display, through the web application server 160, additional content, such as texts or images, to the image or video of restaurant menu captured and displayed on the mobile device 110. For example, when the user 105 hovers the mobile device 110 over the section of the restaurant menu associated with “Cheese Burger,” the mobile device 110 may capture that image and the mobile app may send corresponding data to the web application server 160. The web application server 160 processes the data received from the mobile app and return data related to the merchant's cheese burger. For example, the web application server 160 may associate the location of the mobile device 110 with a merchant at that location, retrieve menu items for the merchant, determine the menu item captured, and retrieve data associated with the captured menu item, such as one or more images, nutritional information, etc. The web application server 160 may then transmit the data that causes the mobile device 100 to display a picture of the cheese burger offered by the restaurant, along with a description of the cheese burger on the menu or any other content associated with the cheese burger. In another example, the data from the web application server 160 may include a video or a link to a video showcasing or describing the food item, such as how the item is made or a commercial/ad for the item. In yet another example, the data from the web application server 160 may enable a 3-D image of the food item to be displayed. The 3-D image may be static or interactive. For the latter, the user 105 may interact with the 3-D image, such as rotating, zooming, and the like to see different views of the food item.

In some embodiments, based on the user's history or other knowledge about the user, the displayed content may be customized. For example, if the user has specific diet preferences or restrictions, the content may be customized to display specific nutritional information related to the diet preferences or restrictions. For example if the user is on a low carbohydrate diet, the number of carbohydrates may be highlighted, or if the user has high cholesterol, the cholesterol numbers may be highlighted. In another example, the user may be known to be interested in how food is prepared, such as determining the user watches numerous cooking shows, the content may include a video of how the food is prepared, along with details about the ingredients. If the user has an interest in history, the displayed content may include a history of the item's recipe or origination. If the user 105 is allergic to certain ingredients, the content may automatically be customized to provide comments or warnings about such ingredients as the user hovers over items, which will enable the user 105 to quickly determine whether an item may not be of interest. The content may also be customized by time of day, year, or other data known about the user. For example, if it is late at night, and the user is known to go to bed soon, caffeine content may be highlighted so that the user can choose lower/no caffeine items. Alternatively, if the user is known to be staying up (such as for a late night study session), caffeine content may be highlighted so that higher caffeine content items may be emphasized for the user.

In some embodiments, prices shown through the mobile device 110 may be different than what is shown on the physical or online restaurant menu. The web application server 160 may adjust the prices based on data or settings from the restaurant at any time or day, which enables the restaurant to offer dynamic pricing without changing the physical menu or requiring the merchant to make changes to the online menu. Such dynamic pricing may also allow the restaurant to improve revenues based on factors, such as incentivizing purchases during off-peak hours or days, incentivizing purchases of certain items during times when the restaurant has excess food of a certain type, raising prices during times when the restaurant is running low on a very popular food item, or offering special pricing on new patrons who the restaurant views as potential repeat customers. The mobile device 110 may display modified prices of the restaurant menu or specific item(s) over prices printed on the restaurant menu. The prices may be changed based on the merchant's instructions, such that physical or online menu may remain unchanged. The prices may change based on predetermined rules set by the merchant, such that the prices may vary based on location, time, day, season, special holidays, restaurant condition, inventory, and the like. As such, when the web application server 160 retrieves data associated with a specific item the user may be interested in, specific rules may be accessed to determine what pricing to display with the displayed menu item. Thus, the restaurant does not need to continually monitor the business to provide real-time instructions for changing prices, but rather this is done automatically by the web application server 160 based on rules and/or conditions set by the restaurant, which can be changed at any time. For example, the system may provide the restaurant a portal that enables the restaurant to see current prices for items and an interface that can be used by the owner to change a price or other content, such as a description, associated with an item on the menu.

If the displayed price is subject to change while the user is deciding what to order. Details of the displayed price may be displayed as well. For example, the displayed price having an indication that it is only be good for 10 minutes from the time the price is first displayed, such as shown either with a timer or an end time. The price may also change based on the number of orders of the specific item. In other embodiments, the prices may be set based on when the user 105 purchases, pays, and/or picks up the item. For example, the system may show different prices for different times or days, such that the user 105 may choose an appropriate time or day to make the purchase, pay for the item, or visit the restaurant. The mobile app may indicate to the user that the product is being offered at a more economical price. For example, the user 105 may decide to visit or purchase at an off-peak time when prices are lower.

In an embodiment, the system may provide user-specific drink and food information for the user. In particular, a customized list of drinks (wine, beer, cocktail, or non-alcoholic) may be generated and presented to the user on the user's device or a merchant device. The customized list may be based on the user's and/or the user's dining group's past purchases or other knowledge about the user and/or other diners with the user, such as a current interest in bourbons, Napa Cabernet, or sparkling waters. The customized list may also be based on a determined occasion for the visit, such as an anniversary, Valentine's Day, bachelor party, guys/girls night out, work promotion with friends, work meal with co-workers, business dinner, birthday, etc. For example, high end or high cost drinks may be shown for a business dinner with a possible expense account, champagnes may be shown for an anniversary dinner, non-alcoholic drinks may be shown for a lunch with co-workers, etc. The determined occasion may be based on the day (e.g., February 14), the day in conjunction with user information (e.g., anniversary), other data accessible by the system associated with the user and others in the user's group, or by simply the user selecting a pre-designated category, such as “business,” “anniversary,” “family,” “guys night out,” “bachelorette party,” etc. Based on the event type, a specific group of suggested beverages may be shown. The suggestions may come from the restaurant, e.g., their list of champagnes can be for an “anniversary” event, some wines will be both “business” and “anniversary”, beers are for “guys night out” and “family”, etc. The specific suggestion per menu item can be based on the list of drinks available for each event, and the restaurant can select the “best” or determined pairings. For example, for ribs as the selected food item, the user may see a restaurant suggestion of wine1, wine3, wine10, champagne2, beer6, beer12, and diet cola. From the user's perspective, the type of event selected will filter down from the list of drinks the restaurant selects to the event type. For example, if the user is at the restaurant for “business”, the user sees only wine1, wine3, and wine10 which were selected as recommended wines for “business,” but not wine2, wine4, and wine9, which were also selected as recommended wines for “business,”, but not recommended wines to be paired with ribs.

In another embodiment, the system may provide suggestions for pairings based on food selected or based on drink(s) selected, such as through an augmented reality view from the mobile device 110. For example, the mobile app may show food matches for each wine selected, along with why each food item may pair well with the selected wine. Alternatively, the mobile app may show wine recommendations based on the food item selected. The wine recommendation may include why the wine may pair well with the particular food item, along with other information such as how the wine is made and information that may be important to the user 105, based on the user 105's history and preferences. For example, the user may be interested in biodynamic wines, Australian wines, aged wines (e.g., wines with at least 5 years of bottle age), or interesting background facts or stories about the wine (such as from a unique grape from a small producer). Such information may be obtained from recent user purchases, travel, online browsing activity, purchased mobile apps, etc.

The customized list or the recommended drink based on the selected food item may be based on additional factors, such as the restaurant's inventory and the availability of the drink or food item at the restaurant in order to promote sales of specific drinks or food items. For example, if a certain wine needs to be moved because it will be out of inventory or that the wine no longer pairs well with current or future menu offerings, such drinks may be highlighted, including reduced pricing or wider ranges of food pairings. In another embodiment, the system will automatically determine one or more replacement drinks if the selected drink is unavailable for whatever reason, such as out of stock or a bad or out of stock ingredient to make the drink or cocktail. The user may then see the alternate drink recommendation(s), along with any relevant information about the drink(s), such as discussed herein.

How a drink or food may pair with a specific food or drink, respectively, may be obtained from feedback from other users who have had such a pairing, either at the restaurant or at other restaurants, in addition to or in place of professional advice on such pairings. Thus, the pairing recommendations can be based on crowd sourced data and/or information available on the Internet and/or Nearchus custom created data, such as articles about food and drink pairings, which can be scraped by the system from publicly available sites or databases. As with selected food items, the system may provide specific content regarding the wine or drink selected. For example, the user may see, through the mobile device 110, information about the winery, a message from the grower and/or the wine maker, a video, the vineyard, or other content specific to the user or to the selected wine or drink.

In an embodiment, the system may implement dynamic recommendations to the user 105. For example, the system may weigh recommendations differently based on other users' similarity with the user 105's preferences and interests. Recommendations and ratings from other users who have similar preferences and interests may weigh more for purpose of providing the recommendations to the user 105. Determining whether another user has similar preferences to the user may be based on a history of restaurants visited, types of food purchased, amount of money spent on dining, and/or content consumed, such as books, movies, shows, podcasts, and blogs. Users may belong to multiple different groups for determining similar preferences, such as BBQ, French, fine dining, food trucks, steakhouses, seafood, Mexican food, fusion food, gastro pubs, health foods, vegetarian, etc. In some embodiments, recommendations may be related to non-food items, such as cleanliness, temperature of restaurant, including a lack of or existence of air conditioning, bathroom, service, density (e.g., how close the tables are to each other), lighting, noise level, and décor. Such information may be used in conjunction with a determined occasion for the visit. In some embodiments, ratings may be provided for a particular item instead of the restaurant as a whole. For example, a restaurant may be well known for a particular food item (e.g., best French fries), such that if a user is known to love French fries, the restaurant may be more highly recommended to the user than to another user who is known to prefer health foods.

In an embodiment, ratings for food, service, value, cleanliness, beverages and the like may be weighted differently based on different users and/or different situations. For example, for an anniversary dinner, the décor and atmosphere of the restaurant may be weighted more, where this may also be user-specific, as one user may enjoy a nicer more refined setting, while another user may like to celebrate anniversaries at loud, high energy restaurants. In an embodiment, the recommendations may be provided based on location to enable the user to experience restaurants at unfamiliar locations similar to what the user is known to like at the user's home or highly frequented locations. For example, the user 105 may be traveling and the system determines the user is at a new city. In this case, the web application server 160 may determine the user location, access the user's dining preferences, access restaurants at the location, and provide recommendations to the user's mobile device for display such that the user may more easily locate restaurants at the new city that are similar to the ones the user 105 enjoys at home or at other familiar locations.

In another embodiment, the system may determine an order or priority in which to present menu items to a user. The order can be based on what the system thinks may be of most interest to the user, such as desserts, appetizers, entrees, cocktails, side dishes, etc., based on factors such as time of day and past purchases, including past purchases at the restaurant, past purchases for the time of day, and recent purchases or visits prior to arriving at the restaurant. Such data, which may be obtained from various sources including databases, user calendars, location data obtained from GPS components of a device of the user, and social networking sites, may provide indications of what the user may be interested in eating and/or drinking at the restaurant. For example, the mobile app may present desserts first on the menu, if the system determines that the user has just arrived at the restaurant and had dinner at another restaurant, such as through a purchase at the other restaurant or determining the user was at the location of the other restaurant during dinner hours. In another example, the system may determine the user is most likely interested in cocktails and light appetizers because a calendar entry (or other available data through a reservation service) indicates the user has a dinner reservation later that day. In that case, the system may communicate data to the user's mobile app that causes the app to display drinks and light appetizers first. Such a prioritized menu display enables displays of mobile devices to be used more efficiently and users to more quickly view relevant content.

In an embodiment, the system may generate recommendations on restaurants and items based on interest groups and/or tribes the user 105 is associated with. For example, the user 105 may be associated with a group/tribe of barbeque lovers, hamburger lovers, dessert lovers, Italian food lovers, pizza lovers, wine lovers, whiskey lovers, beer lovers, and virtually any category of food and/or drink, including subsets of categories, such as red wine lovers, brisket lovers, IPA beer lovers, scotch lovers, and the like. As such, the system may generate recommendations based on ratings, feedback, and/or recommendations from other users who are associated with similar interest groups/tribes. For example, recommendations, ratings, and/or preferences of other users from similar interest groups/tribes may be weighted more when generating recommendations for the user.

Furthermore, recommendations from individual users within a similar interest group/tribe may be weighed differently than other users within the same group/tribe. More highly weighted users may include those that the user follows, is acknowledged as an “expert” or more knowledgeable than others, such as a critic, a restaurant owner, a blogger, a chef, or even someone with a large number of reviews as compared to others in the group/tribe. Such users may be referred to as “influencers,” who may enable others to “follow” him or access various content provided by the influencer. The system may dynamically change the weighting based on the user's feedback from a recommended restaurant. For example, if an influencer (or other user within a similar interest group/tribe) provides a “high recommendation for a restaurant the user selects and dines at, but then provides negative feedback or comments on, that influencer or user may have its weight dropped for this particular user. In similar fashion, users can have their recommendations weighted more heavily when the user's feedback on restaurants match closely with those users.

In an embodiment, in order to incentive users to provide feedback on restaurants they have visited, the system may implement games that reward users for providing feedback, ratings, comments, and the like. For example, the system may initiate a contest, within a certain region or more globally, to find the “best” food item of a particular type (e.g., cheesecake), eat at and rate a list of suggested restaurants, or find the best hamburger under $3.00. At the end of the contest period, such as the end of the day, week, or month, the system may determine one or more winners, such as based on overall ratings by users, factoring in volume and other data like historical ratings, and award those users points or other visual content that distinguish the user from other users. For example, the user may be designated an “influencer” or power review, which can be associated with the specific purpose of the contest, such as the user finishing rating cheesecakes from a list of suggested restaurants. If the user has not finished the list (i.e., has not provided ratings a cheesecake at every restaurant on the list), the user may still be shown has having a higher influence or status than another user who has rated a lower number than the user. In another embodiment, the system may implement a point system. As the user collects points and reaches certain levels, the user's icon may change indicating the respective levels.

FIG. 5B shows the social section of the restaurant detail screen in an example embodiment. In that example, the recommendation interface contains icons that provide information on a variety of criteria. When selected, the Social icon provides access to the social section (step 406) that includes presentation of pictures of the restaurant, décor, menu, food and beverage items, as well as any other pictures that the user would like to upload. In this embodiment, the pictures and information are visible only to the user and those people that the user has selected. However, other embodiments contemplate that the pictures and information may be available to the general public, Facebook™ friends or community, or other groups. As shown in FIG. 7B, the social icon also provides a Flag icon that permits the user to flag this restaurant for later review. The Chat or Message icon permits users to message friends about the particular restaurant. In FIG. 5C, the Calendar icon allows the user to create a calendar event for going to the particular restaurant with other participants. Alternative embodiments may also include other functionality and/or data for collaborative or social sharing of information.

FIG. 5B shows the functionality for posting, showing, and sharing photos relating to selected restaurants. In this example, as the user selected the social section of the restaurant detail screen, the mobile application sends a request for data, in this instance, user photos relating to the selected restaurant, to the web application server. The web application server then requests photos from the external data source and returns that data to the mobile application.

FIG. 5B also shows functionality that the system permits the user to flag a selected restaurant. In that instance, the user selects particular restaurant he or she wishes to flag on the mobile device, and then the mobile application stores the flagging of the selected restaurant on the mobile database. Additionally, the user selection of the flagged restaurant may be sent to the web application server for storage on a database there and returned to the mobile device.

FIG. 5B also illustrates an example of messaging functionality of the system. In this example, the user selects the messaging icon on the mobile device. The mobile application then creates a shortened URL or link for this selected restaurant for this user which is then sent to the web application server. The web app server then returns the shortened URL for this restaurant for this user to the mobile application. The mobile application then sends preformatted shortened URL with message to the messaging application. This pre-formatted text may be edited if desired and then sent to the user's desired recipients.

FIG. 5C similarly illustrates the calendaring functionality of the system. In this example, the user selects the calendaring icon on the mobile device. The mobile application then sends a request to create an internet calendar scheduling file (may be referred to as “ICS”) for the selected restaurant along with the event date and time to the web app server. The web application server returns the created ICS file for the restaurant along with the event date and time to the mobile application. The mobile application sends the pre-formatted text with the shortened URL or link to the messaging application. The pre-formatted text with the shortened URL or link is returned from the messaging application to the mobile application to be edited, if desired, and sent to the recipients.

FIG. 5C further shows the social sharing functionality feature of the system. In this example, the user selects the Facebook™ icon on the mobile device which then sends a transmission from the mobile application containing selected photos, comments, and other data to Facebook™ servers. Facebook™ servers then add the selected photos, comments and data to the user's Facebook™ account. In alternative embodiments, other social sharing sites may be used to aid in similar functionality.

At step 408, the system may present comments sections when comments icon is selected. FIG. 5D illustrates the comments functionality of an example embodiment of the disclosure. In one embodiment, the Comments icon provides a text box to add comments on the restaurant. A user is also able to view comments made by others that describe their experience with the restaurant, as shown in FIG. 7C. These comments as well as other information may be used by artificial intelligence recommendation engine in another embodiment.

In this example, the user selects the comments icon on the mobile device. A request for comment data for the selected restaurant is then sent to the web application server which then sends the request to the external data service. The external data source returns comment data on the selected restaurant to the web application server which then sends it to the mobile application. The mobile application requests user's comments for the selected restaurant which are then sent to the mobile database. The mobile database may then return compiled comment data to the mobile application. Alternatively, the order may be switched so that data is retrieved from the external data service after comments are entered by the user. This data may be used for input into artificial intelligence engine for use in recommendations. It may also provide data useful to the restaurants, merchants or other service or product providers.

At step 408, the system may present the details section when the details icon is selected. FIG. 5E illustrates the restaurant details functionality of an embodiment of the disclosure. This functionality shows detailed data regarding the selected restaurants, as shown in FIG. 7D. In one embodiment, the Details icon provides information regarding the address and phone number of the restaurant, as well as any other contact or relevant information. The phone icon provides for auto-insert of the phone number of the restaurant for easy dialing. The map icon provides for auto-insert of the location of the restaurant on a map functionality. The www icon provides the internet or website link for the restaurant, including links to online order functionality.

In this embodiment, when the user selects the details icon, the mobile application sends a request for details for the selected restaurant to the web application server. The web app server requests restaurant data from an external data source, when then sends the restaurant data to the web app server, which is then sent to the mobile application. Restaurant data may include name, address, telephone number and/or other contact information.

FIG. 5E also illustrates the geomapping or geolocation functionality. When the user selects the map icon on the mobile application, a request is sent to a maps program which launches the map application with the destination's geolocation. The map application may also include driving directions.

In FIG. 5E, when the copy icon is selected, the mobile application creates a shortened URL for this restaurant for this user. The web application server returns the shortened URL for this restaurant for this user and sends back to the mobile application. The shortened URL is then sent to the mobile operating system shared memory which stores it so that the restaurant details are copied with the shortened URL for use by another application.

In FIG. 5E, when the telephone icon is selected, the mobile application sends a request to the telephone program which returns the phone number of the selected restaurant with the interface to activate the phone number and call the restaurant.

At step 410, the system may present the Open Times section when the open times icon is selected. FIG. 5F illustrates functionality of showing when the restaurant is open for business in an example of the disclosure. In one embodiment, the Open Times icon provides information on the times that the restaurant is open for business (as shown in FIG. 7E) as well as local time at the restaurant and whether the restaurant is still open, closed or closing soon. Any restaurant, anywhere in the world can be searched and open times for that restaurant may be communicated as well as the current local time to indicate whether the restaurant is currently open. It is readily contemplated that this interface may contain additional information, such as available seating at the restaurant for specific times as well as booking online functionality.

In this example, the mobile application requests data on times when the restaurant is open for business from the web application server. The web application server requests open times for the selected restaurant from an external data source which returns the open times to the web application server to the mobile application for presentment. Additionally, the mobile application may also show local date and time and whether the restaurant is open or closed according to such local date and time.

At step 414, the system may present the Ratings section when the ratings section is selected. FIG. 5G shows the ratings functionality and data of an embodiment of the disclosure. In one embodiment, the Your Ratings icon provides rating information about several important criteria for restaurants: Food, Service, Value, Beverages, Cleanliness. In the preferred embodiment, the options for ratings are positive, negative and neutral. Many types of ratings are possible, including but not limited to: numerical ratings, grade ratings (for example, A, B, C, etc.), multiple stars, circles or other icons or adjectives (for example, Good, Superior, etc.). Likewise, many other criteria could be chosen for the ratings in addition to or instead of the ones listed above.

In this example, when the user selects the ratings icon, the mobile application sends a query to the web application server requesting the user's previous ratings on the selected restaurant. The web application server queries the server database for this information, and then returns the user's previous ratings on the selected restaurant to the web app server which then sends the data to the mobile application.

The user may then select ratings value which is sent to the mobile application which then stores the user's ratings data on the mobile database. The mobile application posts the value of the rating. Additionally, alternative embodiments contemplate sending the stored ratings value to the web application server for storage on the server database.

At step 416, the system may present the opinions section if the opinions icon is selected. FIG. 5H shows the opinions functionality for multiple criteria and ratings data of an embodiment of the disclosure. In one embodiment, the Your Opinions icon provides ratings information on additional criteria: (1) Family & Kids—Is this restaurant good for families with small kids?; (2) Date Night—Is this restaurant good for a date night?; (3) Happy Hour—Does this restaurant have a good happy hour?; (4) Girls Night Out—Is this restaurant good for a girls' night out?; (5) Guys Night Out—Is this restaurant good for a guys' night out?; (6) Business—Is this restaurant good for a business meal?; (7) Casual—Is this restaurant good for casual dining?; (8) 10 or More—Is this restaurant good for groups larger than 10?; (9) 10 or Less—Is this restaurant good for big groups up to 10?; (10) Singles Night—Is this restaurant good for a singles night out?; (11) Elegant—Is this restaurant good for an elegant meal?; (12) Parking Your Car—Does this restaurant have good parking?; (13) Parking Your Bike—Is this restaurant good for parking your bike?; (14) Outdoor Seating—Does this restaurant have outdoor seating?; (15) WIFI—Does this restaurant have WIFI access? (This opinion may also include the quality of the WIFI (i.e., does the restaurant have good WIFI?), not just whether WIFI is present); (16) Watch TV—Is this restaurant good for watching TV?; (17) Wheelchairs—Does this restaurant have good wheelchair access?; (18) Music—Is this restaurant good for listening to music?; (19) Dancing—Is this restaurant good for dancing with friends? In the preferred embodiment, the options for ratings are positive, negative and undecided or neutral. Many types of ratings are possible, including but not limited to: numerical ratings, grade ratings (for example, A, B, C, etc.), multiple stars, circles or other icons or adjectives (for example, Good, Superior, etc.).

In an embodiment, the user 105 may select one of the various opinion criteria to evaluate. The mobile application then sends the opinion criteria as well as the ratings value to the mobile database to be stored. It also posts the value of rating for that particular opinion criteria. Additionally, alternative embodiments contemplate sending the stored ratings value of the particular opinion criteria to the web application server for storage on the server database.

In another embodiment, the system uses the feedback on ratings from the criteria, including but not limited to, Your Ratings and Your Opinions, to personalize additional recommendations to the user. These ratings may be input into an artificial intelligence recommendation engine that will generate better recommendations based on a user's previous ratings across a wide assortment of criteria.

In one embodiment, recommendations are generated. Data is stored in the web application server that contains ratings concerning restaurant criteria (for example, Food, Service, Value, Beverages, Cleanliness) and/or opinions functionality for multiple criteria and ratings data. Note that ratings for additional or different criteria may be stored or alternatively, ratings for a subset of the afore-mentioned criteria. This ratings data for the selected criteria is then used in an algorithm to numerically score and rank the recommendations. The recommendations are then sent from the web application server to the mobile application.

The recommendations may be personal recommendations for the user and such data may be used to categorize or align the user with other users who show similar preferences or ratings. This data then may be used to form tribes or user groups which then can potentially result in recommendations to others of similar or like tastes or preferences. By way of example (and not limitation), if a particular user rates certain Asian restaurants highly or poorly, those ratings may result in higher quality recommendations to others within that person's user group or tribe.

Artificial intelligence, computer algorithms or other software means may be used to categorize or align users into tribes or user groups with similar tastes or preferences. These means may also be used to provide personalized recommendations. In one embodiment, the restaurant experience is defined as a finite number of discrete observations by the user or customer. For example, the customer's observations or ratings of the restaurant's food quality, service level, value opinion, beverage selection and cleanliness level may be used to define the restaurant experience. The number of discrete observations is not limited to this list, but may contain many additional factors. The customer has the option of rating positively, negatively, or neutrally any or all of these observations. The data of these observations along with the category type of the restaurant such as Chinese, Japanese, Italian, Asian Fusion, etc. may be data points used in the recommendation system for the customer as it pertains to the customer's observations or ratings.

Customers with similar historical observations may be identified together into a community. For example, there may be a community of customers who have similar historical ratings for a particular type of cuisine. The customer is then given access to the collective community's highly rated restaurants as recommendations by the system. Members of a community can share their opinions privately or broadcast them to the entire network. Opinion surveys may be used to gather information such as if the restaurant would be recommended for groups with small children, customers who prefer live music, customers who prefer good access to parking, etc. These data points may also be used to recommend specific interests to the members in the community.

Another embodiment of the disclosure is to provide personal recommendations for users who have similar characteristics or demographics. By way of example (and not limitation), users may be in similar age groups, personal hobbies or interests, or geographic regions. The disclosure also includes groups that follow celebrity leaders. For example, groups may be formed following celebrities, chefs, gourmets, food critics, or other influencers. The disclosure may also include paid or sponsored advertising from restaurants or merchants.

Users may be in multiple tribes or user groups. The system also includes communication channels for soliciting, procuring and receiving recommendations from other users in a user group. There may also be a chat or community channel for relaying restaurant or food experiences, including interactive communication means.

Restaurants may also advertise to users who are within a certain geographic vicinity. For example, a restaurant may offer coupons, discounts or special offers to users who are within a certain vicinity to the restaurant. Such coupons, discounts or special offers may be time-based to maximize flow of customers to the establishment.

In an embodiment, restaurants with the highest personal recommendation (from that user) rank ahead of the restaurants with ratings based on aggregate recommendations. In another embodiment, the restaurants recommendations rank in the order of their numerical score, whether from personal ratings or aggregate ratings. There are many variations of the recommendation display and sort that are contemplated and within the purview of the present disclosure.

In other embodiments, the system may provide merchant side functions and applications, such as supply chain management functions and applications. In some embodiments, the system may facilitate sales and purchases between restaurants, which have unique issues of oversupply not present with non-food merchants. For example, if a restaurant has too much of a certain food item that may spoil or become non-usable after a certain amount of time, such as meat, produce, dairy, etc., the restaurant typically throws those items away, resulting in a loss to the restaurant. In one embodiment, the system manages inventory between restaurants to maximize use of restaurant items. For example, based on business traffic and/or transaction records, the system may determine that merchant A has low inventory for a certain item and merchant B has excess inventory for the same item. The system may automatically suggest or recommend that merchant A purchase the excess inventory from merchant B. The system may facilitate the offer and acceptance of sale and may process the transaction to complete the sale. This can benefit both merchant A and merchant B by enabling merchant B to eliminate or reduce excess inventory and enabling merchant A to potentially purchase that excess inventory at a price less than what merchant A may typically spend. The system may determine current pricing on the item, such as through scraping sites of local suppliers or markets, and suggest a price that is less than the current pricing to both merchant A and merchant B. In other embodiments, merchant B need not be a restaurant, but can be any merchant, person, or entity that may have excess inventory, including a local grocer, a farmer, or even an individual or household.

In another example, the system may provide recommendations to merchants on periodic purchases. Based on inventory history, the system may determine when and how much of certain items the restaurant should purchase to ensure appropriate level of inventory to meet customer demand, while not having excess inventory. For example, the system may determine seasonal or periodic variations on demands, such as weekends, weather conditions, holiday seasons, special local events, new restaurants opening, restaurants closing, and the like, to provide accurate prediction on inventory needs that maybe higher or lower than the normal periodic purchasing. The recommendations may go beyond just reducing or increasing a periodic purchase, but may also include making a special purchase between periodic purchases, such as when a certain item or items are priced lower than if bought as part of the periodic purchase. Alternatively, the recommendation may be for the restaurant to completely forego a periodic purchase and wait for the next period to purchase, such as due to excess inventory or anticipated lower demand.

In an embodiment, the system may provide performance evaluations and recommendations to a merchant, based on the merchant's performance compared to other similar merchants, where similar can be based on type of food, average meal cost, size of restaurant, type of restaurant (e.g., local or chain), etc. For example, the system may mine data, such as available through food apps or sites, blogs, or other crowd-sourced data, to determine whether a certain restaurant is lower higher ratings, lower reviews, and any other negative indicator that is lower than what other similar restaurants or merchants are getting. From this data, such as customer feedback and rating, the system may provide comprehensive analysis on how a merchant is performing on a variety of different areas, such as food quality, service, cleanliness, décor, store hours, prices, and the like, as compared to a more “successful” merchant. For example, a certain food item at the more successful restaurant (restaurant A) may consistently get better reviews than a similar food item at restaurant B. There may be details as why that item gets better reviews, such as through user comments obtained by data mining. In this case, the system may summarize or detail specific areas for improvement.

In another embodiment, the system may search for and/or monitor inventory suppliers and may provide purchase recommendations to merchants. For example, based on restaurant type, other inventory already at the restaurant, and other merchant related information, the system may recommend inventory suppliers that have lower prices on items (food or non-food) that the merchant/restaurant may desire or need, such as an item the merchant is low on or there will be an anticipated need for that item in the near future. In a further example, the system may recommend a specific food item or drink the merchant can offer, even if not part of the merchant's regular menu, based on low pricing on items needed to make that food item or drink. For example, the system may find a supplier with a very low price on tomatoes and recommend the supplier to a diner, along with a suggestion of using the tomatoes to offer a spaghetti dish, even though the diner may not typically have spaghetti on the menu. In this way, the merchant or restaurant owner may be able to generate additional profit, even though other ingredients for the item may not be discounted. As noted above, the recommended supplier and/or item may be non-food, such as chairs, wine glasses, dining wares, kitchen equipment, and the like. For example, when another similar restaurant is going out of business, the system may determine items that are sold at discount and recommend the discounted items to the merchant, especially if the system knows the merchant may need such items now or in the near future, such as due to low inventory, quality upgrades, replacement for old or non-working equipment, etc.

In another embodiment, the system may provide dynamic couponing functions and services to merchants, where incentives are delivered through the user's mobile app or other means on the mobile device 150. In particular, the system may determine a specific incentive to offer or for the merchant to offer specific consumers or groups of consumers. For example, incentive may be an invitation to meet the restaurant owner, chef, sommelier, pastry chef, beverage director, and the like and would be provided to consumers known to value such interactions. In another example, the incentive may be based on the status of the user, such as first time to the restaurant, first time eating out, regular diner, “foodie,” budget eater, fine restaurant diner, and the like and the intended goal of the incentive. For example, the system may generate and offer coupons (e.g., specific discounts) to visit new restaurants for frequent diners with the goal that such diners will become frequent or regular diners at the new restaurant. Goals, which can be as simple as attracting a diner, can be set by the merchant, and the system may determine what incentive and when to offer that incentive for the merchant that results in the best chance of achieving that goal.

In another embodiment of dynamic couponing, the system may generate coupons based on how busy the restaurant is. Broadly, at less busy times, incentives or higher discounts may be provided to users to generate business to the restaurant. In more detail, the incentives may be targeted based on the restaurant, such as excess supply of a certain food/drink item, or an intended user or group, such as food preference, schedule, etc. For example, based on user taste preferences or based on specific known local interest group or tribe, and factoring in calendar events, the system may generate incentives to help target certain users or local users. In some embodiments, the system may generate different incentives based on different interest groups who may come in together, where the value of the incentive may also change based on the number in the group. For example, a group known to be attending a football game may be targeted with incentives that provide a higher and higher discount as more and more eat as part of the group. In another example, based on the schedules of different sports games (basketball, baseball, football, and the like), different groups of sports fans may wish to eat at certain local restaurants as specific times, such as right after the game ends. The system can generate coupons incentivizing specific groups to go to specific restaurants, which can avoid overcrowding at restaurants. In some embodiments, the system may generate coupons based on user location (e.g., at work, at home, traveling, etc.) and time of day (e.g., breakfast, lunch, dinner, after dinner drink, etc.), such that a user may see an incentive for a restaurant near dinner before passing the restaurant, where the restaurant is along the travel route of the user, thereby increasing the likelihood the user goes to the restaurant.

In an embodiment, the system may facilitate service ratings and management functions for the merchants directed to services provided at restaurants. In particular, the system may build performance index for specific services at a restaurant. The performance index may include various data points on how long it takes a customer to experience various service segments of the visit to the restaurant at specific times of the day and days of the week, such as how long the customer is seated after the customer arrives, with and without a reservation, how long the customer is brought a menu after being seated, how long until the customer orders after receiving the menu, how long the customer waits for the food after ordering, how long the customer waits for the check after the meal is finished or the customer asks for the check, how long the customer waits before the check is picked up, and how long the customer waits until the bill is returned for signature. The data points may be used to rate a restaurant on how long customers spend at the restaurant, including at various service intervals, and if customers experience overly long waiting, such as compared to peer restaurants. Using this type of data or performance index provided by the system, the restaurant may be able to improve service times in specific areas, such as hosting, waitressing, busing, or cooking.

On the consumer side, the system may provide restaurant recommendations to customers, based on the customer calendar (e.g., concert after dinner or pick up children) and other user preferences (e.g., likes quick meals), as to user time preferences/constraints. For example, if the system determines based on the user's calendar that the user has limited time for lunch, the system may suggest a nearby restaurant that has speedy service to ensure that the user can be on time for the appointment. In another example, if the system determines the user does not like waiting for a table, but does not mind sitting at the table for longer periods of time (such as based on customer ratings and other feedback), the system may recommend a restaurant having very short wait times for tables, even though the restaurant has long services times after the customer is seated.

Such a performance index can be built based on consumer feedback, such as through the mobile app on the mobile device 150. In one embodiment, consumers are incentivized to provide feedback by awarding points or “money” for each feedback during a visit. For example, when the consumer arrives at the restaurant, the mobile app may determine the consumer's location and launch a screen from the mobile app. The screen may be prepopulated with buttons, such as “arrived,” “seated,” “menu received,” “ordered,” “first food item arrived,” “first drink item arrived,” “last food item arrived,” “check received,” “bill paid,” or any other service data point. In some embodiments, the buttons may be displayed in AR overlaying various locations or places in the venue. Once a button is selected, it may disappear, leaving only unselected buttons remaining on the screen, or the selected button may be deactivated or greyed out. Tapping or otherwise selecting a specific button records a time the button was selected, such that the system may then compile the various time stamps associated with each selection.

In another embodiment, the system may make waiting between various service intervals more pleasant or tolerable for the user/consumer/diner. Specific games for the particular user may be provided through the mobile device 150 or a merchant device provided to the user while at the restaurant. The games may be configured such that the longer a user waits for a service, the easier the game gets. This gives the user a sense of “winning” and may keep the user more engaged in the game and less concerned about the wait. The game can be tailored as an interactive game for the group the user is dining with, such as college students, co-workers, bachelor party, date night, and the like, such that the group is engaged as a whole rather than individuals playing by themselves on the device.

In addition to a performance index for service intervals at a restaurant, the system may generate performance ratings for restaurant employees, such as based on their service for both quality and speed, as well as their ability generate larger checks than others at the restaurant, such as upselling wines or drinks. The ratings may be based on customer feedback as described herein, as well as data obtained through the restaurant, such as amount of average bill, what items were on the bill, etc., and compared with others in similar conditions, e.g., time of day, size of party, etc. Such employee ratings may be available to just the restaurant owner/manager or other select individuals or made public to all employees or users of the mobile app.

The system may provide an addition service to the restaurant, in other embodiments, by enabling the restaurant to more easily and more effectively call workers into the restaurant during anticipated or actual busy times when the restaurant is understaffed. For example, some workers may be on-call and be ready to work when called upon, which the restaurant may do by sending a request from a merchant device to a worker device, such as through a mobile app provided by the system. Availability of works may be determined through a calendar on the merchant device, where workers may have volunteered to be on call or is part of their schedule. The location of available workers may also be shown to the merchant, such as through a map interface. The locations can be determined through GPS functionality of devices associated with the workers, such as their smart phones. The map may then provide a visual interface for the merchant to see which workers are nearby and traffic conditions between workers and the restaurant, and may contact ones likely to arrive soonest to the restaurant, especially if the worker(s) are needed quickly. In an embodiment, the system may facilitate efficient scheduling of workers at the venue based on expected customer traffic, customer type (where certain customers or types of customers may prefer certain workers or types of workers), and the like, which can be based on employee performance ratings and other employee data.

Another service the system can provide is to obtain and process feedback from workers of the restaurant, which can help with obtaining data about consumers as well as more effective scheduling of workers by matching workers with anticipated diners. In an embodiment, the system may provide, through a mobile device of the server or restaurant, an app that, when launched, provides an interface that allows waiters/waitresses/servers to input relevant information about a specific customer. This may provide additional information for dynamic couponing as discussed herein. The server also may record feedback from the customer regarding price, food quality, and the like. The server may provide such information through the device through a pre-populated interface with specific fields or ratings buttons, along with a dialog box for specific comments, which can be input through a keypad or the server speaking into the device. In some embodiments, the server may be called or notified via the server app when a customer requires service at a certain table. The customer may request service from the customer's mobile app, which provides information, such as table number, customer name, or location, to the server device that enables the server to know which table to go to. The request may also contain specific information for the request, such as a request for the bill, for a water refill, etc., that enables the server to more efficiently serve the customer by eliminating the need to go to the table, take the request, and then return. By knowing the request beforehand, the server may already have the requested service ready when the server arrives at the table, thereby eliminating the extra trip to and from the table.

In an embodiment, the system may use Artificial Intelligence (AI) and/or natural language technology to obtain and process ratings, feedback, recommendations, and other content provided by a user (consumer or merchant) discussed herein. For obtaining the feedback, the system may provide capabilities for the user to speak into the mobile device 150, such as through a microphone, where the speech is converted to text data. The system may also enable the user to capture an image of an item at the restaurant and enter comments about the item, such as through typing or voice. The comments are then associated with the item through image recognition.

Once captured, AI can be used to process the data as part of the ratings or recommendation. In particular, user feedback on a variety of review websites and in a variety of formats may be analyzed by a natural language processor and other processors based on different formats (e.g., natural language, emoji, thumbs up/down, rating sale, and the like). For example, user positive comments may be translated into a corresponding number, such as 4 on a 1-5 scale, and user negative comments may be translated into a corresponding number, such as 1. The processor may analyze specific key words, such as “amazing,” “excellent,” “the best,” “horrible,” “okay,” “delicious,” “bland,” etc. to determine a corresponding number value associated with a comment. AI can also weigh or determine key words specific for a user. For example, a user may consistently say “amazing” in reviews, and as such, “amazing” in this user's review may not necessarily equate or contribute to a 5 rating in a 1-5 scale. Thus, use of specific words and the context of such words with other words in past user reviews may be analyzed to determine a suitable or accurate rating for a comment by that user, where the use of same key words by another user may correspond to a higher numerical rating.

In some embodiments, the system may weigh a current feedback based on user feedback history. For example, if a user typically gives 3's out of 5, a rating of 5 is significant and may be weighted more, as compared to another user who consistently gives rating of 5's. In some embodiments, recommendations also may be determined based on the user's browsing history, linger time, favorite restaurants, disliked restaurants (e.g., thumb downs), service feedback, specific features the user focuses on or is most interested in, and the like. Such data may be used by AI to provide more accurate recommendations for a user than conventional recommendations by first obtaining electronic data available through various sources, including databases, Internet sites, user computing devices, and mobile applications, and then analyzing the disparate data sources, based on specific restaurant preferences (food, drink, décor, service, amenities, etc.) specific to the user. The recommendations may further be based on what the AI or processor determines may be the user's next action or decision, such as an upcoming work event, anniversary, or just an expected weeknight dinner.

In another embodiment, the system may provide a merchant dashboard for merchants to manage various functions, as described herein, through a mobile app or webpage on a merchant computing device, such as a PC or smart phone. In addition to the functionality already discussed, such as enabling the merchant to change pricing, set rules, and view on-call employees, the dashboard may also allow the merchant to view details associated with food and drink items sold at various days or times. For example, specific food and drink items may be listed, where the merchant can see information associated with each item, such as next to the item or selecting the item (e.g., clicking or hovering over) to open up a new page or a pop-up. Information may include how many of the item was sold for the day or other period, which can be specified by the merchant, what day/time each of the items was sold, and what other items and how many of the items were purchased with that item. In one embodiment, the merchant dashboard may provide a graphical interface, such as colors, charts, line charts, and the like to present the various data to merchants. For example, color indicators may be used to indicate how busy the workers are at different hours or days. In another example, graphical indicators may be used to indicate a waiter's availability at the restaurant (such as at a busy station or a slow station/area) or available on call.

Thus, the system may provide merchants a variety of different data and analysis, in different formats, to enable a restaurant to improve performance.

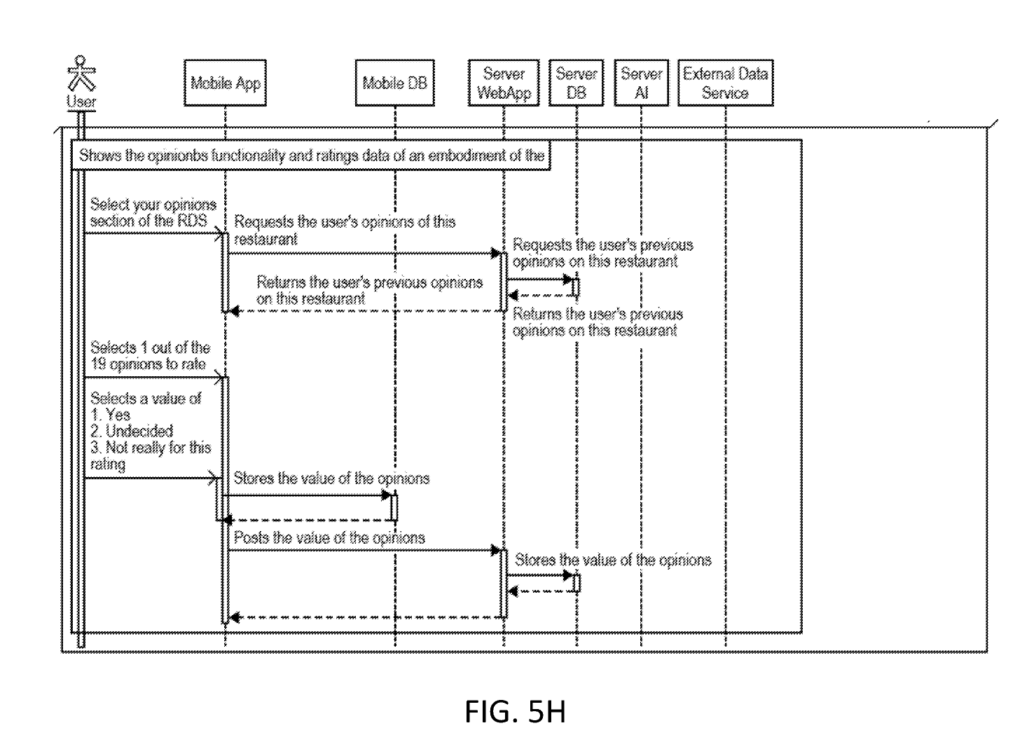

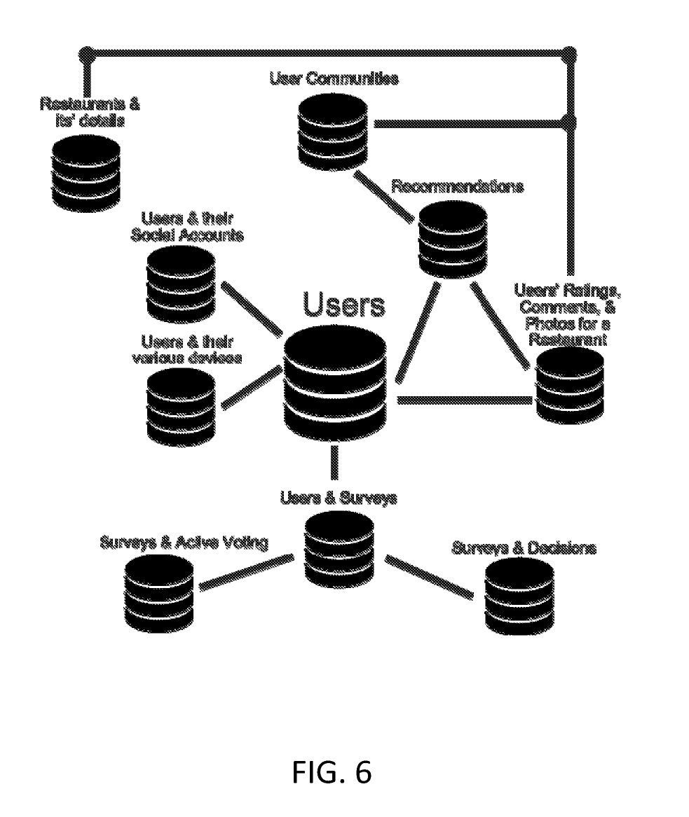

FIG. 6 shows a relational diagram of databases according to an embodiment. It illustrates a flow diagram of the data and information for databases in an example embodiment.

It should be noted that alternative embodiments may be performed using a computer, smart watch, television, automotive video device or any other electronic device rather than a mobile phone or mobile device. Likewise, alternative embodiments may use databases stored on central computers, desktops, laptops or other computers, ASICs, dedicated computer storage, remote servers, and/or cloud computing storage instead of or in addition to the mobile database.

The system may contain numerous databases to store the data and facilitate and process the applications. There are databases that contain customer information, such as user and merchant data. There are databases that contain usage information such as ratings, comments, opinions and survey information. There may be statistical or analytical information which may be used for a variety of purposes including generating restaurant recommendations.

In some embodiments, the system may include a database of restaurants. One method of determining popularity is to compile data for all restaurants that have aggregate ratings of four or in excess of four on a five star rating scale. All such restaurants meeting such criteria are then stored in the database for recommended restaurants. Another method is to determine subsets of desired classifications or features and recommend restaurants with high ratings in those categories. It is readily contemplated that the ratings baseline may be adjusted upwards or downwards to compile the database of recommended restaurants. Likewise, the recommended restaurant database may be determined by other criteria as well, including but not limited to, restaurants offering discounts or coupons, advertising, browsing or search popularity, new or “hot” restaurants, personal recommendations, and other criteria.

In this database, restaurants are assigned a unique identifier. The database also contains data on the longitude and latitude of the restaurant. Thus a restaurant may be recommended at one location, but not another, which takes into account food quality, cleanliness, service and other criteria that may vary widely at various restaurant locations, particularly considering that restaurant franchises may well be under different management. The table also contains data on the number of unique ratings per restaurant per venue which provides information that may be useful regarding the strength or reliability of the restaurant ratings. With a smaller sample set of ratings, the restaurant ratings may be subject to high variability while restaurants showing a high score across a large number of ratings are more likely to score consistently and reliably higher in the criteria.

In an embodiment, the system may include a database storing ratings for the various attributes for each specific restaurant as identified by its unique identifier. The database may include ratings data such as that found in FIG. 5G and described in detail herein. The database may also include opinions data such as that found in FIG. 9 and described in detail herein.

There may also be an additional database that contains the business attributes for each of the restaurants by its unique identifier. For example, the name, address, phone number, hours of operation, location on map, etc. for a restaurant. Additional databases may also contain photos and comments as well as data showing the date and time created, location, photo names, and other information associated with the photos and comments.

The system may include databases containing information related to the users. By way of example, data may be collected regarding user name, identity, location, email address, social network identification, phone number, address, and perhaps user demographic information or other attributes. There may also be information collected on the computer, mobile phone or device identifier as well as type of device and operating system.

As the system may be used with many types of merchants in addition to restaurants, the system may include databases with attributes and information relevant to merchants. For example, a database may store merchant identifier, phone number, address, email and other information for users within the merchant (by way of example and not limitation, owner, manager, receptionist, sales staff, cashier, hostess, administrator, engineer, technician, employee, contractor, etc.). Databases may also store product information, price information, currency, website address, address, availability, types of services, and any other data relevant to the merchant.

Additionally, the system may be used with entities that provide services or other products. It is useful for communication and collaboration for any group of people who are meeting or seeking decision-making on an activity, location, or time. By way of example and not limitation, the system can be used for communication and collaboration regarding concerts, movies, sports events, work or project milestones/deadlines, retail, gym workouts, trips, etc.

In one embodiment, the user can search by specific name of the restaurant or by type of cuisine in the area shown by the map that is represented on the screen of the mobile device. By zooming in or out, the map resizing is used to refine the search area. The user may enter any location in the world which will then resize the map and provide search results of restaurants in that location. For example, if a user input “Tokyo, Japan” in the dialog box, then the restaurants for the map view of Tokyo, Japan would then appear as icons on the map or in list form. The user is able to set their Current Location to any location in the world. It should be appreciated that results may be viewed in different formats and are not limited to the ones described herein.

This embodiment contains database information including location of the restaurant, longitude and latitude, vicinity and other geographic and identifying data.

In an embodiment, the system also contains databases related to the survey and communication channel. There may be database containing information on any of the following: survey name, identifier, originator of survey, survey recipients, short URL, duration of survey, group name, phone numbers or other contact information, restaurant names, categories, dates, times, location, comments, survey results, and the like. The system may manage and organize the various databases to provide appropriate and meaningful information to the users.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

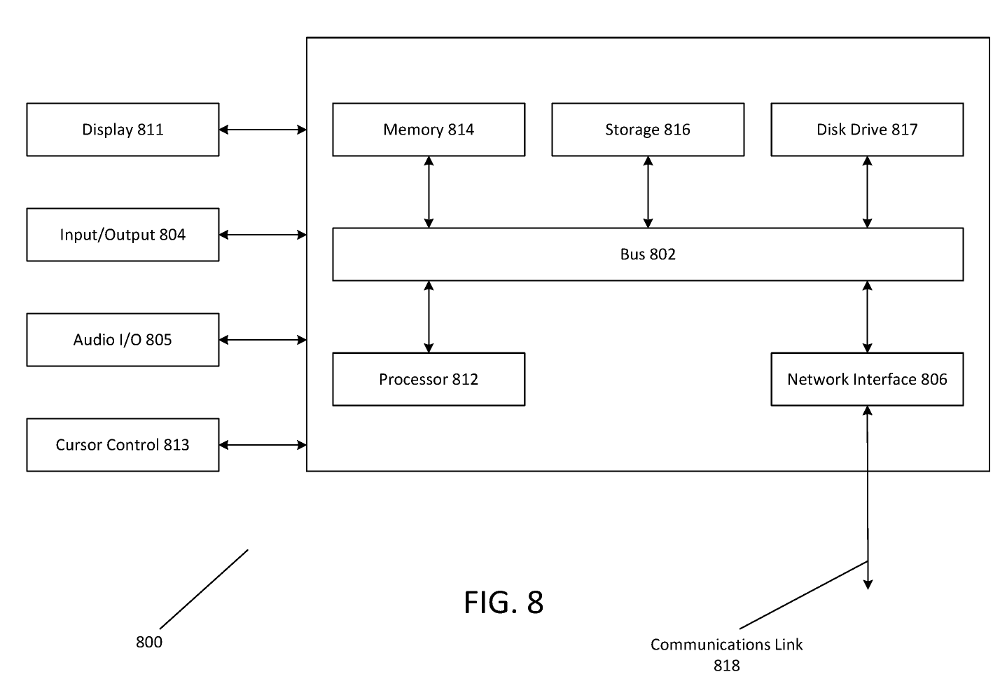

FIG. 8 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 800 in a manner as follows.

Computer system 800 includes a bus 802 or other communication mechanism for communicating information data, signals, and information between various components of computer system 800. Components include an input/output (I/O) component 804 that processes a user action, such as selecting keys from a keypad/keyboard, selecting one or more buttons, image, or links, and/or moving one or more images, etc., and sends a corresponding signal to bus 802. I/O component 804 may also include an output component, such as a display 811 and a cursor control 813 (such as a keyboard, keypad, mouse, etc.). An optional audio input/output component 805 may also be included to allow a user to use voice for inputting information by converting audio signals. Audio I/O component 805 may allow the user to hear audio. A transceiver or network interface 806 transmits and receives signals between computer system 800 and other devices, such as another communication device, service device, or a service provider server via network 170. In one embodiment, the transmission is wireless, although other transmission mediums and methods may also be suitable. One or more processors 812, which can be a micro-controller, digital signal processor (DSP), or other processing component, processes these various signals, such as for display on computer system 800 or transmission to other devices via a communication link 818. Processor(s) 812 may also control transmission of information, such as cookies or IP addresses, to other devices.

Components of computer system 800 also include a system memory component 814 (e.g., RAM), a static storage component 816 (e.g., ROM), and/or a disk drive 817. Computer system 800 performs specific operations by processor(s) 812 and other components by executing one or more sequences of instructions contained in system memory component 814. Logic may be encoded in a computer readable medium, which may refer to any medium that participates in providing instructions to processor(s) 812 for execution. Such a medium may take many forms, including but not limited to, non-volatile media, volatile media, and transmission media. In various embodiments, non-volatile media includes optical or magnetic disks, volatile media includes dynamic memory, such as system memory component 814, and transmission media includes coaxial cables, copper wire, and fiber optics, including wires that comprise bus 802. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 800. In various other embodiments of the present disclosure, a plurality of computer systems 800 coupled by communication link 818 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system comprising:
a non-transitory memory; and
one or more hardware processors coupled to the non-transitory memory and configured to read instructions from the non-transitory memory to cause the system to perform operations comprising:
receiving, at a service provider server, a request for organizing an event from a mobile application executing on a user device associated with a user;
determining a location of the user device;
in response to the receiving, determining a plurality of venues within a predetermined distance of the location of the user device, based at least in part on a tribe associated with the user;
generating a survey webpage based on the plurality of venues;
determining a plurality of potential participants for the event;
accessing contact information of the plurality of potential participants stored in the user device to select, among a plurality of communication channels, a first communication channel for communicating with the plurality of potential participants; and
automatically transmitting a shortened URL link associated with the survey webpage to the plurality of potential participants via the first communication channel.

2. The system of claim 1, wherein the operations further comprise:
receiving survey response data from at least a subset of the plurality of potential participants initiated through the shortened URL link; and
generating a venue recommendation for the event based on the received survey response data.

3. The system of claim 2, wherein the survey response data is received via the survey webpage, and wherein the survey response data comprises at least a selection of one of the plurality of venues.

4. The system of claim 2, wherein the operations further comprise transmitting the venue recommendation to the user device via the first communication channel.

5. The system of claim 2, wherein the operations further comprise determining that the subset of the plurality of potential participants comprises a majority of the plurality of potential participants.

6. The system of claim 1, wherein determining the plurality of venues comprises:
determining a plurality of users who have provided recommendation data associated with at least one venue in a set of venues within the predetermined distance of the location of the user device;
selecting, from the plurality of users, a subset of users by comparing attributes of the plurality of users against attributes of the user; and
obtaining the recommendation data provided by the subset of users, wherein the plurality of venues is determined based on the obtained recommendation data.

7. The system of claim 1, wherein the first communication channel is a text messaging channel, wherein transmitting the shortened URL link to the plurality of potential participants comprises instructing a messaging application installed on the user device to send text messages comprising the shortened URL link to phone numbers of the plurality of potential participants indicated in the contact information.

8. The system of claim 1, wherein the operations further comprise causing the plurality of venues to be displayed on a display of the user device.

9. The system of claim 8, wherein the operations further comprise causing attributes of the plurality of venues to be displayed on the display.

10. The system of claim 8, wherein the operations further comprise:
causing a map based on the location of the user device to be displayed on the display; and
providing graphical representations on the map indicating locations of the plurality of venues.

11. The system of claim 8, wherein the operations further comprise:
instructing a camera of the user device to capture an image;
augmenting the image by superimposing information associated with the plurality of venues on the captured image; and
causing the augmented image to be displayed on the display of the user device.

12. The system of claim 11, wherein augmenting the image comprises:
identifying an area of the captured image that corresponds to a location of a first venue among the plurality of venues; and
superimposing attributes of the first venue on the area of the captured image.

13. A method comprising:
receiving a request for organizing an event from an application executing on a user device associated with a first user;
in response to the receiving, determining, by one or more hardware processors, a plurality of merchants within a predetermined distance of a location;
determining possible times and/or dates for the event;
generating, by the one or more hardware processors, a survey webpage based on the plurality of merchants and the possible times and/or dates;
determining, by the one or more hardware processors, a plurality of potential participants for the event;
accessing, by the one or more hardware processors, contact information of the plurality of potential participants stored in the user device to select, among a plurality of communication channels, a first communication channel for communicating with the plurality of potential participants; and
automatically transmitting, by the one or more hardware processors, a URL link associated with the survey webpage to the plurality of potential participants via the first communication channel.

14. The method of claim 13, further comprising:
receiving survey response data from at least a subset of the plurality of potential participants; and
generating a merchant recommendation for the event based on the received survey response data.

15. The method of claim 14, wherein the survey response data is received via the survey webpage, and wherein the survey response data comprises at least a selection of one of the plurality of merchants.

16. The method of claim 13, wherein determining the plurality of merchants comprises:
determining a plurality of users who have provided recommendation data associated with at least one merchant in a set of merchants within the predetermined distance of the user device;
selecting, from the plurality of users, a subset of users by comparing attributes of the plurality of users against attributes of the first user; and
obtaining the recommendation data provided by the subset of users, wherein the plurality of merchants is determined based on the obtained recommendation data.

17. The method of claim 16, wherein determining the plurality of merchants further comprises:
assigning weights to the recommendation data provided by the plurality of users, wherein the weights assigned to the recommendation data provided by the subset of users are higher than the weights assigned to the recommendation data provided by users who are not part of the subset of users; and
computing, for each venue, a score based on the weighted recommendation data, wherein the plurality of merchants is determined based on the scores computed for the set of merchants.

18. The method of claim 16, wherein a similarity between attributes of each user in the subset of users and attributes of the first user exceeds a predetermined threshold.

19. A non-transitory machine readable medium having stored thereon machine-readable instructions executable to cause a machine to perform operations comprising:
in response to receiving a request for organizing an event from a user device associated with a user, determining a plurality of venues within a predetermined distance of a location of the user device;
generating a survey webpage based on the plurality of venues;
determining a plurality of potential participants for the event;
accessing contact information of the plurality of potential participants stored in the user device to select, among a plurality of communication channels, a particular communication channel for communicating with the plurality of potential participants;
automatically transmitting a URL link associated with the survey webpage to the plurality of potential participants via the particular communication channel;
receiving survey response data from at least a subset of the plurality of potential participants initiated through the URL link; and
generating a venue recommendation for the event based on the received survey response data.

20. The non-transitory machine readable medium of claim 19, wherein the operations further comprise:
instructing a camera of the user device to capture an image;
augmenting the image by superimposing information associated with the plurality of merchants on the captured image; and
displaying the augmented image on a display of the user device.
